(19) United States
(12) Patent Application Publication
(10) Pub. No.: US 2010/0075862 A1
(43) Pub. Date: Mar. 25, 2010

(54) HIGH SENSITIVITY DETERMINATION OF THE CONCENTRATION OF ANALYTE MOLECULES OR PARTICLES IN A FLUID SAMPLE

(75) Inventors: David C. Duffy, Somerville, MA (US); David M. Rissin, Medford, MA (US); Linan Song, Woburn, MA (US); David R. Walt, Boston, MA (US)

Correspondence Address: WOLF GREENFIELD & SACKS, P.C., 600 ATLANTIC AVENUE, BOSTON, MA, 02210-2206, US

(73) Assignee: Quanterix Corporation, Cambridge, MA (US)

(21) Appl. No.: 12/236,484

(22) Filed: Sep. 23, 2008

(51) Int. Cl. C40B 30/04; C40B 40/00

(52) U.S. Cl. 506/9; 506/13

(57) ABSTRACT

The present invention relates to methods, systems, and kits for detecting, quantifying and/or analyzing a fluid sample comprising molecules or particles at low concentration. In certain embodiments, the methods for detection and/or quantifying analyte molecules in a sample comprise capturing a plurality of analyte molecules on a substrate (e.g., an array comprising a plurality of reaction vessels). The substrate may then be exposed to additional reaction components such as at least one binding ligand. The substrate may additionally be exposed to a precursor labeling agent molecule, wherein the precursor labeling agent molecule, in some cases, is converted to a labeling agent molecule, which may be detected, either directly or indirectly, which determination may be related to the presence of and/or may be employed to quantify the analyte molecules. Although the various aspects of the present invention may use a number of different assay formats, in one embodiment, the assays are conducted in a plurality of reaction vessels defined, at least in part, by the distal ends of fiber optic strands.

### FIELD OF THE INVENTION

The present invention relates to systems and methods for detecting analyte molecules or particles in a fluid sample and in some cases, determining a measure of the concentration of the molecules or particles in the fluid sample.

### BACKGROUND OF THE INVENTION

Methods and systems that are able to quickly and accurately detect and, in certain cases, quantify a target analyte molecule or particle in a sample are the cornerstones of modern analytical measurements. Such systems and methods are employed in many areas such as academic and industrial research, environmental assessment, food safety, medical diagnosis, and detection of chemical, biological and/or radiological warfare agents. Advantageous features of such techniques may include specificity, speed, and sensitivity.

Most current techniques for quantifying low levels of analyte molecules in a sample use amplification procedures to increase the number of reporter molecules in order to be able to provide a measurable signal. For example, these known processes include enzyme-linked immunosorbent assays (ELISA) for amplifying the signal in antibody-based assays, as well as the polymerase chain reaction (PCR) for amplifying target DNA strands in DNA-based assays. A more sensitive but indirect protein target amplification technique, called immunoPCR (see Sano, T.; Smith, C. L.; Cantor, C. R. Science 1992, 258, 120-122), makes use of oligonucleotide markers, which can subsequently be amplified using PCR and detected using a DNA hybridization assay (see Nam, J. M.; Thaxton, C. S.; Mirkin, C. A. Science 2003; 301, 1884-1886; Niemeyer, C. M.; Adler, M.; Pignataro, B.; Lenhert, S.; Gao, S.; Chi, L. F.; Fuchs, H.; Blohm, D. Nucleic Acids Research 1999, 27, 4553-4561; and Zhou, H.; Fisher, R. J.; Papas, T. S. Nucleic Acids Research 1993, 21, 6038-6039). While the immuno-PCR method permits low-level protein detection, it is a complex assay procedure, and can be prone to false-positive signal generation (see Niemeyer, C. M.; Adler, M.; Wacker, R. Trends in Biotechnology 2005, 23, 208-216).

One disadvantage of many known methods and systems for accurately detecting and quantifying low concentrations of a particular analyte in solution is that they are based on ensemble responses in which many analyte molecules give rise to the measured signal. Most detection schemes require that a large number of molecules are present in the ensemble for the aggregate signal to be above the detection threshold. This disadvantage limits the sensitivity of most detection techniques and the dynamic range (i.e., the range of concentrations that can be detected). Many of the known methods and techniques are further plagued with problems of non-specific binding, which is the binding of analyte molecules/particles to be detected or reporter species non-specifically to sites other than those expected. This leads to an increase in the background signal, and therefore limits the lowest concentration that may be accurately or reproducibly detected.

Accordingly, improved methods for detecting and, optionally, quantifying analyte molecules or particles, especially in samples where such molecules or particles are present at very low concentration are needed.

### SUMMARY OF THE INVENTION

The present invention relates to systems and methods for detecting analyte molecules or particles in a fluid sample and in some cases, determining a measure of the concentration of the molecules or particles in the fluid sample. The subject matter of the present invention involves, in some cases, interrelated products, alternative solutions to a particular problem, and/or a plurality of different uses of one or more systems and/or articles.

In one aspect, the invention is directed towards a method. According to one set of embodiments, a method of detecting analyte molecules or particles in a fluid sample containing or suspected of containing analyte molecules or particles, comprises partitioning the fluid sample across an array comprising a plurality of reaction vessels, so that at least some of the reaction vessels contain no analyte molecules or particles and at least some of the reaction vessels contain at least one analyte molecule or particle, immobilizing at least one binding ligand with respect to an analyte molecule or particle within each reaction vessel containing at least one analyte molecule or particle, exposing the at least one binding ligand to a liquid in which is solubilized or suspended precursor labeling agent molecules, wherein exposure of the precursor labeling agent molecules to the at least one binding ligand converts at least some of the precursor labeling agent molecules into a labeling agent molecules which are insoluble in the liquid and/or which become immobilized within the reaction vessel, and determining from detecting the presence of the labeling agent molecules the number of reaction vessels which contain an analyte molecule or particle.

In another aspect, the invention is directed towards a system. According to one set of embodiments, a system for detecting analyte molecules or particles, comprises an array comprising a plurality of reaction vessels, wherein at least some of the reaction vessels contain no analyte molecules or particles and at least some of the reaction vessels contain at least one analyte molecule or particle, at least one binding ligand immobilized with respect an analyte molecule or particle within each reaction vessel containing an analyte molecule or particle, and precursor labeling agent molecules solubilized or suspended in a liquid contained within the reaction vessels, wherein the precursor labeling agent molecules are able to convert upon exposure to a binding ligand to labeling agent molecules that are insoluble within the liquid and/or that become immobilized within reaction vessels containing a binding ligand.

In another embodiment, a method of detecting analyte molecules or particles in a fluid sample containing or suspected of containing analyte molecules or particles, comprises providing a fluid sample containing or suspected of containing analyte molecules or particles, immobilizing at least one binding ligand with respect to at least some of the analyte molecules or particles, exposing the at least one binding ligand to a liquid in which is solubilized or suspended precursor labeling agent molecules, wherein exposing the precursor labeling agent molecules to the at least one binding ligand converts at least some of the precursor labeling agent molecules into labeling agent molecules which are insoluble in the liquid and/or which become immobilized within the reaction vessel, and determining a measure of the concentration of the analyte molecules or particles in the fluid sample based on the detection of labeling agent molecules wherein the true concentration of the analyte molecules or particles in the fluid sample is less than about 100×10⁻¹⁵ molar, and wherein the measure of the concentration determined in the determining act differs from the true concentration by no greater than 10%.

In another aspect, the invention is directed towards a kit. According to one set of embodiments, a kit for detecting analyte molecules or particles comprises an array comprising a plurality of reaction vessels, each reaction vessel having a volume not exceeding about 100 femtoliters and each reaction vessel containing at least one analyte capture component immobilized or able to become immobilized within the reaction vessels having binding specificity for the analyte molecules or particles, at least one binding ligand having binding specificity for the analyte molecules or particles, and precursor labeling agent molecules able to be solubilized or suspended in a liquid, wherein the precursor labeling agent molecules are able to convert upon exposure to the at least one binding ligand to labeling agent molecules that are insoluble within the liquid and/or that become immobilized within the reaction vessels.

In another set of embodiments, a method of detecting analyte molecules or particles in a fluid sample containing or suspected of containing analyte molecules or particles, comprises partitioning the fluid sample across an array comprising a plurality of reaction vessels, so that at least some of the reaction vessels contain no analyte molecules or particles and at least some of the reaction vessels contain at least one analyte molecule or particle, immobilizing at least one binding ligand comprising a binding site with respect to an analyte molecule or particle within each reaction vessel containing at least one analyte molecule or particle, applying an enzymatic component to the array and capturing the enzymatic component with the binding site, contacting the enzymatic component with precursor labeling agent molecules, wherein the precursor labeling agent molecules are converted to labeling agent molecules upon contact with enzymatic components, detecting the labeling agent molecules, and determining from the detection of the labeling agent molecules the number of reaction vessels which contain an analyte molecule or particle.

### BRIEF DESCRIPTION OF THE DRAWINGS

FIG. 1 is a schematic flow diagram depicted a sequence of steps (A-G) for performing an assay according to some embodiments of one method of the present invention;

FIG. 2 is a schematic flow diagram depicting a sequence of steps (A-I) according to some embodiments of one method of the present invention;

FIGS. 3A-3D is a schematic flow diagram illustrating the conversion of a precursor labeling agent molecule into a labeling agent molecule and direct or indirect detection of the labeling agent molecule, according to some embodiments;

FIG. 4A is a schematic diagram depicting an experimental set-up for detection using light, according to one embodiment of the present invention;

FIG. 4B is a schematic diagram showing a fiber optic array that has been sealed with a sealing component, according to one embodiment;

FIG. 4C shows a photocopy of a photograph of an entire fiber optic array, according to one embodiment;

FIG. 5 is a schematic flow diagram depicting an embodiment of a method (steps A-D) for the formation of a plurality of reaction vessels through mating of a substrate and a sealing component and depicting examples of the size (panels E, F) of a sealing component relative to a substrate;

FIG. 6A is a photocopy of a microscopic photograph of an entire fiber optic array and an inset close-up of the bundle, according to one embodiment of the present invention;

FIG. 6B is a photocopy of an AFM image of a portion of an etched surface of a fiber optic array, according to one embodiment of the present invention;

FIG. 7 is a schematic diagram showing side view cross-sectional views of an etched fiber optic bundle that forms an array of microwells (panels A-D), according to one embodiment of the present invention, and depicting the localization of a capture component within a reaction vessel (panels E-G), according to some embodiments of the present invention;

FIG. 8 is a schematic flow diagram illustrating a non-limiting example of one assay method of the present invention;

FIGS. 9A and 9B are schematic diagrams showing a system employing and optical detection system of the present invention according to some embodiments;

FIG. 10 is a schematic block diagram showing a system employing a fiber optic assembly with an optical detection system according to an embodiment of the invention;

FIG. 11 shows a graph of a schematic calibration curve of a form that may be used to determine the concentration of an analyte molecule or particle in a fluid sample, according to some embodiments of the present invention;

FIGS. 12A and 12B show images of a fiber optic array analyzed in a non-limiting example of the present invention, with and without sealing of the array, respectively;

FIG. 13 shows a calibration curve determined when using an array that was sealed, according to one embodiment of the present invention;

FIG. 14 shows a calibration curve determined for a non-limiting example of the present invention;

FIG. 15 shows a plot of the number of active wells when using an array of the present invention for the detection of TNF-alpha, according to one embodiment.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Systems and methods for the detection and/or quantification of analyte molecules, particles (such as, for example, cells, cell organelles and other biological or non-biological particulates) and the like, in a sample are described herein. The subject matter of the present invention involves, in some cases, interrelated products, alternative solutions to a particular problem, and/or a plurality of different uses of one or more systems and/or articles. It should be understood, that while much of the discussion below is directed to analyte molecules, this is by way of example only, and other materials may be detected and/or quantified, for example, analyte particles. Particular examples of analytes will be discussed more below.

The systems and methods of the present invention, in certain embodiments, may help reduce the negative effects of non-specific binding on detection sensitivity when compared to typical conventional systems and methods for performing similar assays. Non-specific binding is the binding or association in a non-specific fashion of one component of an assay with another component of the assay with which it is not desirable that it interact. For example, association, binding, or immobilization of a binding ligand with the material forming a reaction vessel wall as opposed to with an analyte molecule or particle to which it has binding specificity. Non-specific binding may lead to false positive signals. Non-specific binding may not only affect the accuracy of the assay measurement, but may also limit the lowest level of detection. Therefore, methods and/or systems of the present invention, which in certain embodiments involve improvements in the level of non-specific binding, may allow for the detection and/or quantification of analyte molecules in a sample at a lower detection limit as compared to typical current technologies.

In certain embodiments, the methods for detection and/or quantifying analyte molecules in a sample comprise capturing a plurality of analyte molecules on a substrate (e.g., an array comprising a plurality of reaction vessels). The substrate may then be exposed to additional reaction components such as at least one binding ligand, as discussed more below. The substrate may additionally be exposed to a precursor labeling agent molecule, wherein the precursor labeling agent molecule, in some cases, is converted to a labeling agent molecule, which may be detected, either directly or indirectly, which determination may be related to the presence of and/or may be employed to quantify the analyte molecules.

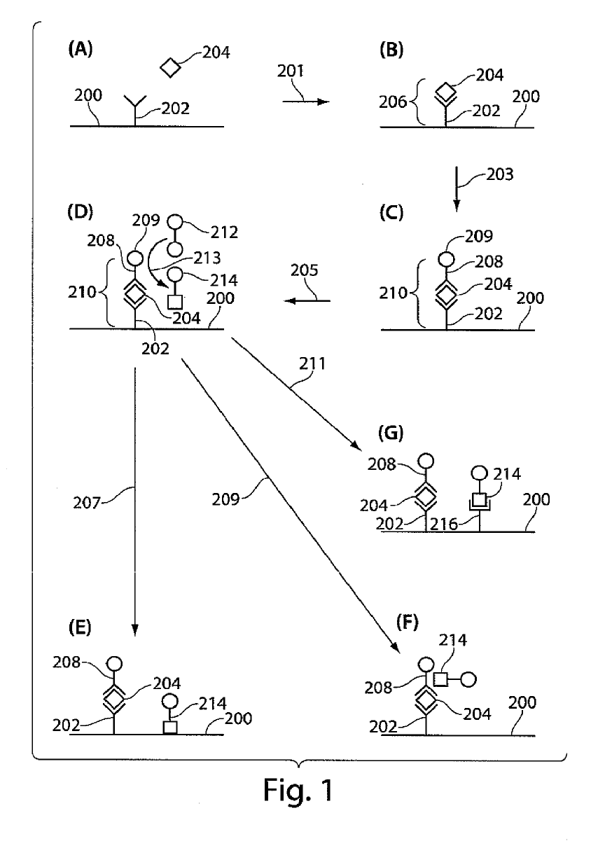

An exemplary assay method according to some embodiments of the present invention is illustrated in FIG. 1. In this particular non-limiting example, only a first binding ligand is provided; however, in other embodiments, additional binding ligands could be employed, as described in more detail below. Substrate 200 comprising a capture component 202 is exposed to analyte molecule 204 (step (A)). Analyte molecule 204 associates with capture component 202, as indicated by arrow 201, thereby forming analyte molecule-capture component complex 206 (step (B)). The substrate is then exposed to binding ligand 208 and binding ligand 208 may associate with analyte molecule 204, as indicated by arrow 203, thereby forming analyte molecule-capture component-binding ligand complex 210 (step (C)). Binding ligand 208 may comprise a component 209 which is capable of converting a precursor labeling agent molecule into a labeling agent molecule. The reaction vessel may then be exposed to precursor labeling agent molecule 212, as indicated by arrow 205, which upon exposure to binding ligand 208, is converted to labeling agent molecule 214, as indicated by arrow 213 (step (D)). The labeling agent molecule may be insoluble and, optionally, forms a precipitate and/or become immobilized with respect to the substrate, as discussed herein. Various assay methods and suitable reaction components (e.g., analyte molecules or particles, binding ligands, precursor labeling agent molecules, labeling agent molecules, etc.) are discussed more herein.

In certain embodiments, precursor labeling agent molecules are converted into labeling agent molecules upon exposure to a binding ligand. A “precursor labeling agent molecule” is any molecule, particle, or the like, that is able to be converted to a labeling agent molecule upon exposure to a suitable binding ligand. In some cases, the binding ligand may comprise a converting agent to promote the conversion. For example, the binding ligand may comprise an enzymatic component, a gold nanoparticle, etc. A “labeling agent molecule” is any molecule, particle, or the like, that facilitates detection, by acting as the detected entity, using a chosen detection technique.

In some embodiments, a precursor labeling agent molecule is converted into a labeling agent molecule that is insoluble. For example, as shown in FIG. 1, labeling agent molecule 214 is insoluble and precipitates (Step (E)), as indicated by arrow 207.

In other embodiments, a precursor labeling agent molecule is converted into a labeling agent molecule that is immobilized with respect to the substrate. In some cases, the labeling agent molecule will be immobilized with respect to the substrate by associating with a labeling agent capture component which is associated with the substrate. For example, the surfaces within the reaction vessels (including microwells defined in fiber optical bundles) may incorporate at least one labeling agent capture component. For example, as shown in FIG. 1, Step (G), substrate 200 comprises at least one labeling agent capture component 216. Labeling agent molecule 214 becomes associated with labeling agent capture component 216, as indicated by arrow 211, and is immobilized with respect to substrate 200.

In certain cases, the labeling agent molecule will be immobilized within the reaction vessel by associating with a binding ligand. For example, the labeling agent molecule may be able to associate or interact with the binding ligand such that the labeling agent molecule is immobilized within the reaction vessel. For example, as shown in FIG. 1, Step (F), labeling agent molecule 214 becomes associated with binding agent 208, as indicated by arrow 209.

In some embodiments of the present invention, more than one binding ligand may be provided in an assay method. A “binding ligand,” as used herein, is any molecule, particle, or the like which specifically binds to or otherwise specifically associates with an analyte molecule or another molecule that binds to or otherwise associates with the analyte molecule (e.g., another binding ligand). In instances where a first and a second binding ligand are be employed in any given assay method, the first binding ligand is able to associate with an analyte molecule and the second binding ligand is able to associate with the first binding ligand. When the substrate is exposed to a plurality of types of binding ligands, at least some of the plurality of immobilized complexes may additionally comprise, in some cases, at least one of each type of binding ligand. In certain embodiments, the binding ligand can be exposed to the substrate after capture of the analyte molecule so that the binding ligand binds to the immobilized complex. In other embodiments, the binding ligand may become associated with the analyte molecule to form a complex followed by capture of the complex by the substrate to form the immobilized complex. The binding ligands may be provided in certain embodiments in an amount sufficient such that at least one of each type of binding ligand comes into contact with every immobilized analyte molecule on the binding surface of the plurality of reaction vessels. At least one type of binding ligand may in certain embodiments comprise a converting agent which promotes conversion of a precursor labeling agent molecule into a labeling agent molecule, as discussed more herein.

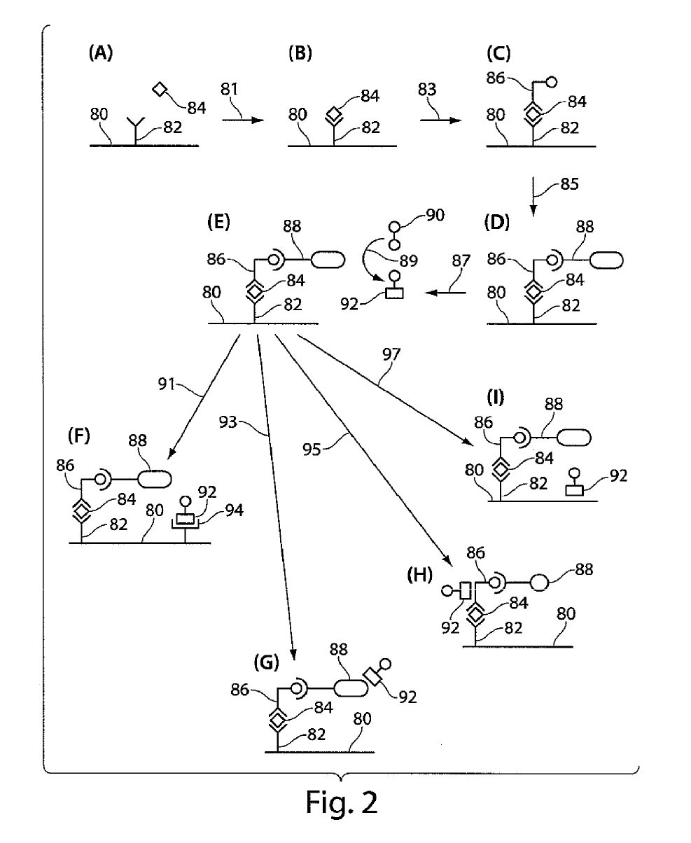

In certain embodiments, a first and a second binding ligand may be used. The first binding ligand may associate with the analyte molecule and the second binding ligand may associate with the first binding ligand. For example, as shown in FIG. 2, substrate 80 comprising capture component 82 is exposed to analyte molecule 84 (step (A)). Analyte molecule 84 associates with capture component 82, as indicated by arrow 81 (step (B)). Substrate 80 is then exposed to first binding ligand 86 and first binding ligand 86 associates with analyte molecule 84, as indicated by arrow 83 (step (C)). Substrate 80 is then exposed to second binding ligand 88 which associates with first binding ligand 86, as indicated by arrow 85 (step (D)). At least one of first or second binding ligand may comprise a converting agent. The substrate is additionally exposed to precursor labeling agent molecule 90, as indicated by arrow 87, which upon exposure to converting agent comprised in either first or second binding ligand, is converted to labeling agent molecule 92, as indicated by arrow 89 (step (E)). The labeling agent molecule may be insoluble and/or immobilized with respect to substrate 80, as discussed more herein. For example, as indicated by arrow 91, labeling agent molecule 92 may be immobilized in the reaction vessel by associating with labeling agent capture component 94 (step (F)). In other instances, labeling agent 92 may associate with a binding ligand, for example, second binding ligand 88, as indicated by arrow 93 (step (G)), or first binding ligand 86, as indicated by arrow 95 (step (H)). In yet other instances, labeling agent molecule 92 may be insoluble and remain in the reaction vessel, as indicated by arrow 97 (step (I)). In some instances, at least two, at least three, at least four, at least five, at least eight, at least ten, or more, types of binding ligands may be provided. In some cases, at least one binding ligand may comprise a binding side, wherein the binding site is capable of capturing an enzymatic component.

In some embodiments, the method comprises partitioning a fluid sample containing or suspected of containing at least one analyte molecule or particle across a plurality of reaction vessels. The plurality of reaction vessels may comprise an array, for example, a fiber optic array. The fluid sample may be partitioned such that at least some of the reaction vessels contain at least one or, in certain cases, one analyte molecule or particle, and at least some of the reaction vessels contain zero analyte molecules or particles, at discussed more herein. In some embodiments, the fluid sample may be partitioned such that a statistically significant fraction of reaction vessels contains about at least one or, in certain cases, one analyte molecule or particle and a statistically significant fraction of reaction vessels contains zero analyte molecules or particles.

It should be understood, that while most of the discussion herein primarily focuses on analyte molecules, this is by way of example only, and other materials may be detector or quantified, for example, analyte particles, such as cells, subcellular organelles and/or non-biological particles. Other example of analyte molecules are discussed more herein.

In some embodiments, the plurality of analyte molecules will be immobilized with respect to a substrate. In particular embodiments, the substrate comprises an array of reaction vessels. The plurality of reaction vessels are exposed to a fluid (e.g. a liquid) sample containing or suspected of containing at least one analyte molecule of interest. In some cases, the analyte molecules are immobilized in the reaction vessel (or otherwise with respect to the substrate). The analyte molecule may be immobilized in the reaction vessel by association with a capture component on a binding surface of a reaction vessel. For example, in the context of a substrate comprising microwells, the interaction between any analyte molecule and the capture component on the binding surface of a microwell results in immobilization of the analyte molecule within that microwell. For example, the analyte molecule may be immobilized by a capture component on the binding surface within each reaction vessel under conditions suitable for capture of the analyte molecule by at least one of the capture components (e.g., physiological conditions).

A “capture component”, as used herein, is any molecule, other chemical/biological entity or solid support modification disposed upon a solid support that can be used to specifically attach, bind or otherwise capture molecules or particles, such as an analyte molecule, labeling agent molecule, etc. such that the molecule becomes immobilized with respect to the capture component and solid substrate. As used herein, “immobilized” means captured, attached, bound, or affixed so as to prevent dissociation or loss of the target molecule/particle, but does not require absolute immobility with respect to either the capture component or the solid substrate. Capture components which are useful or potentially useful for practicing certain aspects and embodiments of the invention are discussed in more detail below. The term “analyte agent capture component” is sometimes used herein, for clarity to refer to a capture component having specific affinity for a an analyte molecule or particle. Similarly, the term “labeling agent capture component” is sometimes used to refer to a capture component having specific affinity for a labeling agent. At least some of the analyte molecules, upon exposure to the plurality of reaction vessels comprising a plurality of analyte capture components, can become immobilized with respect to analyte capture components, thereby forming a plurality of immobilized complexes. For example, in certain embodiments, substantially all of the plurality of analyte molecules may become immobilized with respect to capture components such that essentially each of the plurality of immobilized complexes comprises a capture component and an analyte molecule.

In certain embodiments, the plurality of analyte molecules are partitioned across a plurality of reaction sites, such as, for example, a plurality of reaction vessels (e.g., in an array format). The plurality of reaction vessels may be formed in or of any suitable material, and in some cases, the reaction vessels can be sealed or may be formed upon the mating of a substrate with a sealing component, as discussed in more detail below. In certain embodiments, especially where quantification of the analyte molecules is desired, the partitioning of the analyte molecules is performed such that at least some reaction vessels comprise at least one or, in certain cases, only one analyte molecule and at least some reaction vessel comprise no analyte molecules. The analyte molecules may be detected in certain embodiments, thereby allowing for the detection and quantification of the analyte molecule in the fluid sample by techniques described in more detail below.

Certain methods of the present invention may be useful for characterizing analyte molecules in a sample. In some cases, the methods may be useful for detecting and/or quantifying analyte molecules in a fluid sample which is suspected of containing at least one analyte molecule, since, as explained in more detail below, the number of reaction vessels which contain one or more of the analyte molecules can be correlated to the concentration of analyte molecules in the fluid sample (e.g., the number of reaction vessels which comprise an analyte molecule can be related to a measure of the concentration of the analyte molecules in the sample) under certain conditions. Certain embodiments of present invention thus can provide a measure of the concentration of analyte molecules in a fluid sample based on the proportion of reaction vessels which contain an analyte molecule. Specific methods and calculations of how to quantify analyte molecules in a fluid sample using embodiments of the invention are discussed more below.

In some embodiments, the plurality of reaction vessels (or substrate) may be washed at least once. In one instance, the plurality of reaction vessels may be washed after contacting the array with a solution comprising analyte molecules, binding ligands, precursor labeling agent molecules, or the like. In this instance, the wash step may be used to wash away any molecules that are not immobilized with respect to the plurality of reaction vessels. The wash step may be performed by any method known to those skilled in the art, for example, by placing the plurality of reaction vessels in a wash solution. In some cases, the wash solution may be a solution that does not cause change to the surface of the plurality of reaction vessels or the interaction between at least two components of the assay (e.g., a capture component and an analyte molecule).

The methods of certain embodiments of the present invention may be used to characterize analyte molecules in the fluid sample. In some cases, the methods may be used to detect and/or quantify analyte molecules in a fluid sample which is suspected of containing at least one analyte molecule. That is, there is correlation between the numbers of reaction vessels which containing one or more analyte molecules and the concentration of analyte molecules in the fluid sample. Certain embodiments of present invention allow for the quantification of the amount of analyte molecules in a fluid sample based on the percentage of reaction vessels determined to contain an analyte molecule. Specific methods and calculations of how to quantify analyte molecules in a fluid sample are discussed more herein.

In some embodiments, the number of reaction vessels which contain an analyte molecule is determined by determining the number of reaction vessels which contain at least one labeling agent molecule. That is, the number of reaction vessels which contain a labeling agent molecule is proportional to the number of reaction vessels which contain an analyte molecule. The method of detecting the number of reaction vessels which contain labeling agent molecules will depend on the labeling agent being detected. For example, the labeling agent molecule may be an optical label or a spectroscopic or radiolabel, etc.

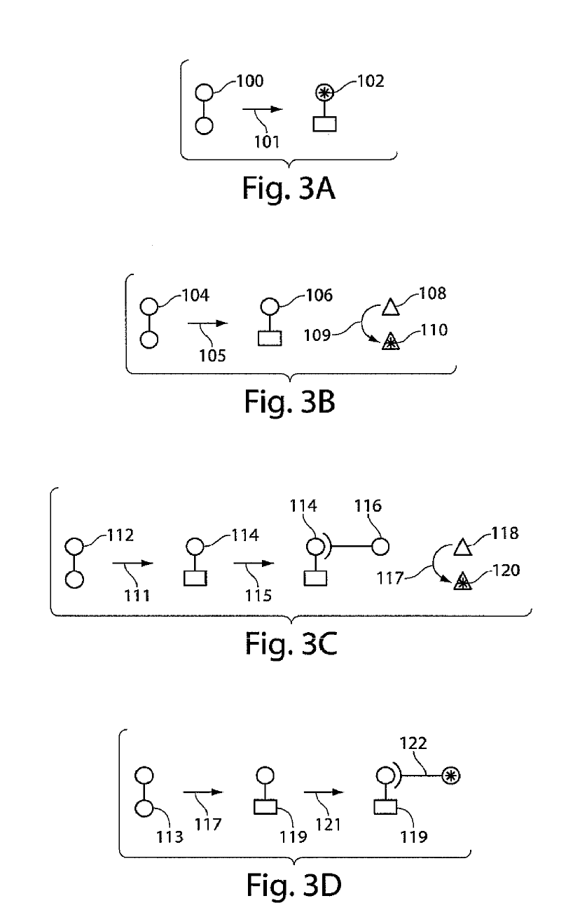

A labeling agent molecule may be detected directly or indirectly. A labeling agent molecule is detected directly if the labeling agent molecule itself is detected by direct interrogation of a reaction vessel. For example, the precursor labeling agent molecule may be converted to a labeling agent molecule that is fluorescent, chemiluminescent, forms a precipitate, or the like. A non-limiting example of direct detection is depicted in FIG. 3A. Precursor labeling agent molecule 100 is converted, as indicated by arrow 101, to labeling agent molecule 102 which may be detected directly using a suitable detection system.

In other instances, the labeling agent molecule may be detected indirectly, for example, in instances where the labeling agent molecule itself is not directly detectable. A precursor labeling agent molecule may be converted into a labeling agent molecule and then the labeling agent molecule may be exposed to a labeling agent reactant. In some cases, the labeling agent reactant may be converted to a detectable product (e.g., a fluorogenic product) upon exposure to the labeling agent molecule. For example, as shown in FIG. 3B, a precursor labeling agent molecule 104 is converted to labeling agent molecule 106, as indicated by arrow 105, which is not directly detectable. Labeling agent molecule 106 is exposed to a labeling agent reactant 108, which is converted to a detectable product 110, as indicated by arrow 109. In some cases, however, the labeling agent reactant may be detectable directly (e.g., without conversion into a detectable product). For example, the labeling agent reactant may be fluorogenic, chromogenic, etc. molecule/particle/compound which is able to associate with the labeling agent molecule. For example, as shown in FIG. 3D, a precursor labeling agent molecule 113 is converted to labeling agent molecule 119, as indicated by arrow 117, which is not directly detectable. Labeling agent molecule 119 is exposed to a labeling agent reactant 122, which associates with labeling agent molecule and comprises a detectable component. In other cases, the labeling agent molecule may be exposed to a first labeling agent reactant and a second labeling agent reactant. The first labeling agent reactant may associate with the binding ligand and the second labeling agent reactant may be converted to a detectable product upon exposure to the first labeling agent reactant. For example, as shown in FIG. 3C, precursor labeling agent molecule 112 is converted to labeling agent molecule 114, as indicated by arrow 111. Labeling agent molecule 114 is exposed to a first labeling agent reactant, 116, as indicated by arrow 115, wherein first labeling agent reactant 116 associates with labeling agent molecule 114. First labeling agent reactant 116 is then exposed to second labeling agent reactant 118, which is converted to detectable product 120 as indicated by arrow 117. In a particular embodiment, the first labeling agent reactant may comprise an enzymatic component and the second labeling agent reactant may comprise an enzymatic substrate. For example, the first labeling agent reactant may become immobilized with respect to the binding ligand. The immobilized first labeling agent reactant may be exposed to a second labeling agent reactant (e.g., an enzymatic substrate) and the enzymatic substrate may be converted to a detectable product.

In certain embodiments, the systems and/or methods of the present invention can be employed in an assay using a first and a second substrate, wherein the first substrate may comprise beads or a microtitre plate and the second substrate is configured as describe herein. In certain such assays, the analyte molecules or particles are contacted with the first substrate, and a dissociated reporter molecule/particle is then released from the first substrate, which is then detected using the second substrate. For example, the systems and/or methods of the present invention may be used in combination with the systems and/or methods as described in commonly owned U.S. patent application Ser. No. (not yet determined), filed Sep. 23, 2008, entitled “Ultra-Sensitive Detection of Enzymes by Capture-And-Release Followed by Quantification” by Duffy, et al. (Attorney Docket No. Q0052.70009US00); U.S. patent application Ser. No. (not yet determined), filed Sep. 23, 2008, entitled “Ultra-Sensitive Detection of Molecules by Capture-And-Release Using Reducing Agents Followed by Quantification” by Duffy, et al. (Attorney Docket No. Q0052.70008US00); and U.S. patent application Ser. No. (not yet determined), filed Sep. 23, 2008, entitled “Ultra-Sensitive Detection of Molecules On Single Molecule Arrays” by Duffy, et al. (Attorney Docket No. Q0052.70007US00).

One of ordinary skill in the art will appreciate that the range of materials that may be employed in the discussed methods is numerous and the following sections provide a broad overview of only a non-limiting list of exemplary materials and techniques.

### Arrays of Reaction Vessels

Certain embodiments of the present invention utilize an array of reaction vessels to carry out steps in an assay utilized to determine the concentration of an analyte molecule of interest. An array of reaction vessels allows a fluid sample to be partitioned into a plurality of discrete reaction volumes during one or more steps in an assay. In some embodiments, the reaction vessels may all have approximately the same volume.

In other embodiments, the reaction vessels may be of differing volumes. The volume of each individual reaction vessel can range for different embodiments from attoliters or smaller to nanoliters or larger depending upon the nature of analyte molecules, the detection technique and equipment employed, and the expected concentration of the analyte molecules in the fluid applied to the array for analysis. In one embodiment, the size of the reaction vessel may be selected such that at the concentration of interest, between zero and ten analyte molecules or particles would be statistically expected to be found in each reaction vessel. In a particular embodiment, the volume of the reaction vessel is selected such that at the concentration of interest, either zero or one analyte molecules or particles would be statistically expected to be found in each reaction vessel. In accordance with one embodiment of the present invention, the reaction vessels may have a volume between about 1 femtoliter and about 1 picoliter, between about 10 femtoliters and about 100 femtoliters, between about 10 attoliters and about 50 picoliters, between about 1 picoliter and about 50 picoliters, between about 1 femtoliter and about 1 picoliter, between about 30 femtoliters and about 60 femtoliters, or the like. In some cases, the reaction vessels have a volume of less than about 1 picoliter, less than about 500 femtoliters, less than about 100 femtoliters, less than about 50 femtoliters, less than about 1 femtoliter, or the like. In some cases, the reaction vessels have a volume of about 10 femtoliters, about 20 femtoliters, about 30 femtoliters, about 40 femtoliters, about 50 femtoliters, about 60 femtoliters, about 70 femtoliters, about 80 femtoliters, about 90 femtoliters, or of about 100 femtoliters.

For embodiments employing an array of reaction vessels, the number of reaction vessels in the array will depend on the composition and end use of the array. Arrays containing from about 2 to many billions of reaction vessels can be made by utilizing a variety of techniques and materials. Increasing the number of reaction vessels in the array can be used to increase the dynamic range of an assay or to allow multiple samples or multiple types of analyte molecules to be assayed in parallel. Generally, the array will comprise between one thousand and one million reaction vessels per sample to be analyzed. In some cases, the array will comprise greater than one million reaction vessels. In some embodiments, the array will comprise between about 1,000 and about 50,000, between about 1,000 and about 1,000,000, between about 1,000 and about 10,000, between about 10,000 and about 100,000, between about 100,000 and about 1,000,000, between about 1,000 and about 100,000, between about 50,000 and about 100,000, between about 20,000 and about 80,000, between about 30,000 and about 70,000, between about 40,000 and about 60,000, or about 50,000, reaction vessels.

The array of reaction vessels may be arranged on a substantially planar surface or in a non-planar three-dimensional arrangement. The reaction vessels may be arrayed in a regular pattern or may be randomly distributed. In a specific embodiment, the array is a regular pattern of sites on a substantially planar surface permitting the sites to be addressed in the X-Y coordinate plane.

In some embodiments, the reaction vessels are formed in a solid material. As will be appreciated by those in the art, the number of potentially suitable materials in which the reaction vessels can be formed is very large, and includes, but is not limited to, glass (including modified and/or functionalized glass), plastics (including acrylics, polystyrene and copolymers of styrene and other materials, polypropylene, polyethylene, polybutylene, polyurethanes, Teflon®, polysaccharides, nylon or nitrocellulose, etc.), composite materials, ceramics, silica or silica-based materials (including silicon and modified silicon), carbon, metals, optical fiber bundles, or the like. In general, the substrate material may be selected to allow for optical detection without appreciable autofluorescence. In certain embodiments, the reaction vessels may be formed in a flexible material. In yet other embodiments, the reaction vessels may be formed in a material that is both flexible and solid.

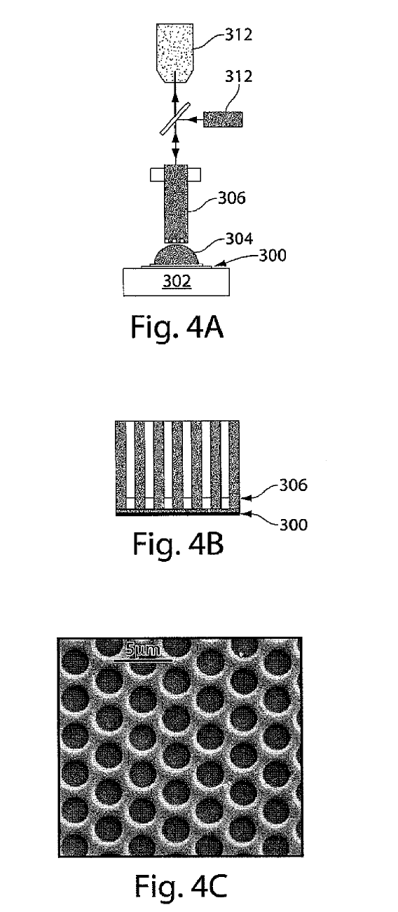

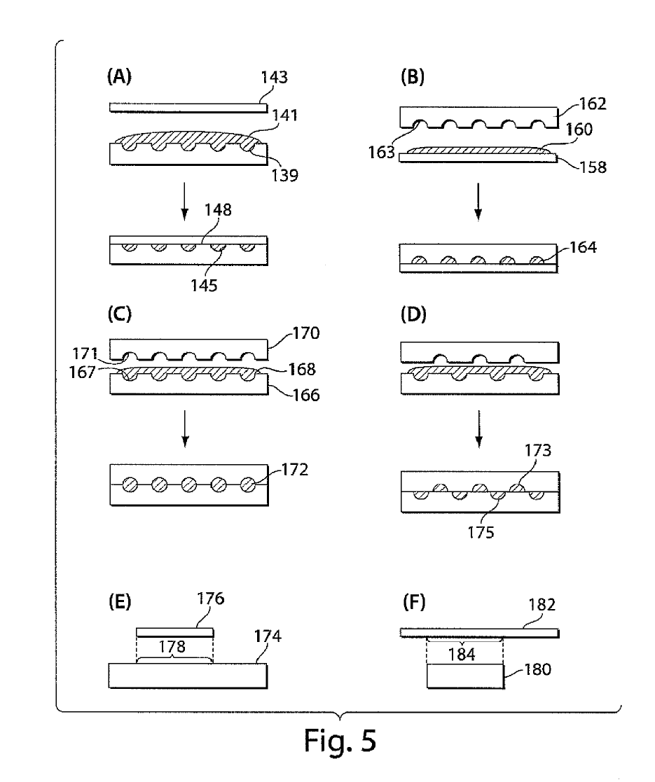

In some embodiments of the present invention, the plurality of reaction vessels may be formed through the mating of the substrate and a sealing component, wherein at least one of the substrate and the sealing component comprises a plurality of microwells. In some cases, an array comprises a plurality of depressions in a first surface of the substrate (e.g., a support material). The sealing component may comprise a second surface with the same or different topology as the first surface may be brought into contact with the first surface to create a plurality of sealed reaction vessels. Either the first surface or the second surface may be fabricated from a compliant material to aid in sealing. Either or both of the surfaces may be hydrophobic or contain hydrophobic regions to minimize leakage of aqueous samples from the microwells. In some cases, the sealing component may be capable of contacting the exterior surface of an array of microwells (e.g., the cladding of a fiber optic bundle as shown in FIG. 4B) such that each reaction vessel thus formed is sealed or isolated such that the contents of each reaction vessel cannot escape the reaction vessel. According to one embodiment, the sealing component may be a silicone elastomer gasket that may be placed against an array of microwells with application of uniform pressure across the entire substrate. In some cases, the reaction vessels may be sealed after the addition of an analyte molecule and, optionally, a precursor labeling agent molecule to facilitate detection of the analyte molecules. For embodiments employing precursor labeling agent molecules, by sealing the contents in some of each reaction vessel, a reaction to produce the detectable labeling agent molecule can proceed within the sealed reaction vessels, thereby producing a detectable amount of a labeling agent molecule that is retained in the reaction vessel for detection purposes. In some cases, the plurality of reaction vessels formed on a substantially planar substrate upon the mating of at least a portion of a sealing component comprising a plurality of microwells and at least a portion of the substantially planar substrate (e.g., see FIG. 5B below).

Non-limiting embodiments of the formation of a plurality of reaction vessels on a substrate are depicted in FIG. 5. FIG. 5, panel (A) shows a surface comprising a plurality of microwells 139, which have been exposed to a fluid sample 141, and a sealing component 143. Sealing component 143 in this example comprises a substantially planar bottom surface. Mating of the microwell containing surface 139 with sealing component 143 forms a plurality of sealed reaction vessels 145. The areas between the reaction vessels 148 may be modified to aid in the formation of a tight seal between the reaction vessels.

A second embodiment is shown in FIG. 5, panel (B), in which sealing component 162 comprising a plurality of microwells 163 is mated with a substantially planar surface 158 which has been exposed to fluid sample 162, thereby forming a plurality of reaction vessels 164.

In a third embodiment, as shown in FIG. 5, panel (C), substrate surface 166 comprising a plurality of microwells 167 is mated with sealing component 170 also comprising a plurality of microwells 171. In this embodiment, the microwells in the substrate and the microwells in the sealing components are substantially aligned so each reaction vessel 172 formed comprises a portion of the microwell from the sealing component and a portion of a microwell from the substrate. In FIG. 5, panel (D), the microwells are not aligned such that each reaction vessel comprises either a microwell from the sealing component 173 or a microwell from the substrate 175.

The sealing component may be essentially the same size as the substrate or may be different in size. In some cases, the sealing component is approximately the same size as the substrate and mates with substantially the entire surface of the substrate. In other cases, as depicted in FIG. 5, panel (E), the sealing component 176 is smaller than the substrate 174 and the sealing component only mates with a portion 178 of the substrate. In yet another embodiment, as depicted in FIG. 5, panel (F), the sealing component 182 is larger than the substrate 180, and only a portion 184 of the sealing component mates with the substrate 180.

Individual reaction vessels may contain a binding surface. The binding surface may comprise essentially the entirety or only a portion of the interior surface of the reaction vessel or may be on the surface of another material or object that is confined within the reaction vessel, such as, for example, a bead, or a particle (for example, a micro-particle or a nanoparticle).

A microwell in a surface (e.g., substrate or sealing component) may be formed using a variety of techniques known in the art, including, but not limited to, photolithography, stamping techniques, molding techniques, etching techniques, or the like. As will be appreciated by those of the ordinary skill in the art, the technique used will depend on the composition and shape of the supporting material and the size and number of reaction vessels.

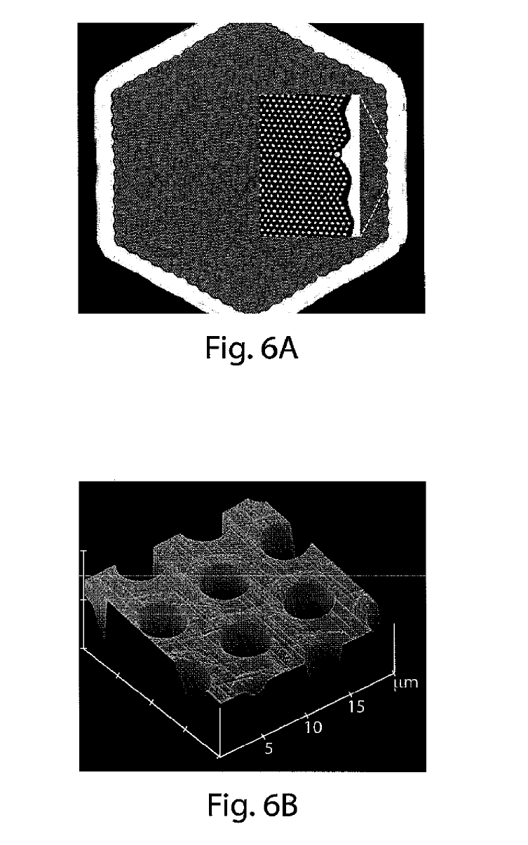

In a particular embodiment, an array of reaction vessels is formed by creating microwells on the end of a fiber optic bundle and utilizing a substantially planar compliant surface as a sealing component. In certain such embodiments, an array of reaction vessels in the end of a fiber optic bundle may be formed as follows. First, an array of microwells is etched into one end of a polished fiber optic bundle. Techniques and materials for forming and etching a fiber optic bundle are known to those of ordinary skill in the art. For example, the diameter of the optical fibers, the presence, size and composition of core and cladding regions of the fiber, and the depth and specificity of the etch may be varied by the etching technique chosen so that microwells of the desired volume may be formed. In certain embodiments, the etching process creates microwells by preferentially etching the core material of the individual glass fibers in the bundle such that each well is approximately aligned with a single fiber and isolated from adjacent wells by the cladding material. Potential advantages of the fiber optic array format is that it can produce thousands to millions of reaction vessels without complicated microfabrication procedures and that it can provide the ability to observe and optically address many reaction vessels simultaneously. An example of an etched fiber optic array is shown in FIGS. 6A and 6B. FIG. 6A shows a fiber optic array that has been etched to form a plurality or reaction vessels. In this particular example, the wells have a diameter of approximately 4.5 microns and a volume of about 46 fL. FIG. 6B shows an AFM image of a portion of the fiber optic array of FIG. 6A. FIG. 4C also shows another picture of a fiber optic array.

Each microwell may be aligned with an optical fiber in the bundle so that the fiber optic bundle can carry both excitation and emission light to and from the wells, enabling remote interrogation of the well contents. Further, an array of optical fibers may provide the capability for simultaneous or non-simultaneous excitation of molecules in adjacent vessels, without signal “cross-talk” between fibers. That is, excitation light transmitted in one fiber does not escape to a neighboring fiber.

In certain embodiments of the present invention, the physical alterations to a fiber optic may be made as taught in U.S. Pat. Nos. 6,023,540, 6,327,410, and 6,858,394. Any one or more of the surface of the glass microwells, the surface of the sealing component, or particles within microwells can be functionalized in certain embodiments to create binding surface(s).

Alternatively, the equivalent structures can be fabricated using other methods that do not utilize the ends of an optical fiber bundle as a substrate. For example, the array may be a spotted, printed or photolithographically fabricated substrate produced by techniques known in the art; see for example WO95/25116; WO95/35505; PCT US98/09163; U.S. Pat. Nos. 5,700,637, 5,807,522, 5,445,934, 6,406,845, and 6,482,593.

In certain embodiments, the present invention provides a system equipped with a mechanical platform that applies a sealing component to a substrate. The platform may be positioned beneath a stage on the system. After the chosen reaction components have been added to an array of reaction vessels, the sealing component may be mated with the array. For example, the sealing component may be sandwiched between a flat surface (such as, for example, a microscope slide) and the array of reaction vessels using uniform pressure applied by the mechanical platform.

A non-limiting embodiment of such equipment is illustrated in FIG. 4A. A sealing component 300 is placed on top of mechanical platform 302. The fluid sample 304 is placed on top of the sealing component 300. The mechanical platform is moved upwards towards the array 306 (e.g., fiber optic array) such that uniform pressure is applied. As shown in FIG. 4B, the sealing component 300 forms a tight seal with the array 306. In other instances, varying pressure may be applied to the sealing component to form a tight seal between the sealing component and the array. The system may also comprise additional components 312 that may be utilized to analyze the array (e.g., microscope, computer, etc.) as discussed more herein.

In one embodiment of the present invention, the array of reaction vessels may be sealed. The array may be sealed by contacting a sealing component with the face of an array of reaction vessels, thereby fluidically isolating each reaction vessel and sealing its contents therein. In some cases, an array comprises a plurality of depressions in a first surface of a support material. The sealing component has a second surface with the same or different topology as the first surface may be brought into contact with the first surface to create an array of sealed reaction vessels. Either the first surface or the second surface may be fabricated from a compliant material to aid in sealing. Either or both surfaces may be hydrophobic or contain hydrophobic regions to minimize leakage from the microreactors of aqueous components.

A “sealing component,” as used herein, is defined as any material or device large enough to cover at least a portion, or in certain cases, an entire array of reaction vessels, and which is capable of contacting the exterior surface of the array of reaction vessels (e.g., the cladding of a fiber optic bundle) such that each reaction vessel thus formed is sealed or isolated such that the contents of each reaction vessel cannot escape the reaction vessel under assay conditions employed. According to one embodiment, the sealing component is a silicone elastomer gasket that is placed against the array of reaction vessels with application of uniform pressure across the entire substrate. In some cases, the reaction vessels may be sealed after the addition of precursor labeling agent molecules and/or reactants. By sealing the contents in each reaction vessel, the reaction may proceed within the reaction vessel thus formed, thereby producing a detectable amount of a detectable product that is retained in the reaction vessel for detection purposes. For example, the labeling agent molecule may convert a substrate into a chromogenic, fluorogenic, or chemiluminescent product that builds up to a locally high concentration in each sealed reaction vessel, thereby generating a detectable chromogenic, fluorogenic, or chemiluminescent signal in the reaction vessel.

In some embodiments, the array to which the analyte molecules or particles are immobilized may be subjected to at least one washing step. In one instance, an array may be washed after exposing the substrate to one or more solutions comprising analyte molecules, binding ligands, precursor labeling agent molecules, etc. In some instances, the wash step(s) may be used to wash away any analyte molecules or non-analyte molecules, any binding ligands or non-binding ligands, or any precursor labeling agent molecules or non-precursor labeling agent molecules that are not immobilized with respect to the substrate. The wash step(s) may be performed by any suitable technique known to those of ordinary skill in the art, for example, by submersion of the substrate in a wash solution, flushing the substrate with a wash solution, etc. In certain embodiments, the wash solution is selected so that it does not cause appreciable change to the configuration of the substrate surface and/or does not disrupt an interaction between at least two components of the assay (e.g., a capture component and an analyte molecule). In other cases, the wash solution may be a solution that is selected to chemically interact with one or more components of the substrate. As will be understood by those of ordinary skill in the art, a wash step may be performed at any appropriate time point during the inventive methods (e.g., after exposure of the array to a reagent or after immobilization of and agent with respect to an array) during a method of the present invention.

### Exemplary Target Analytes

As will be appreciated by those in the art, a large number of analyte molecules and particles may be detected and, optionally, quantified using methods and systems of the present invention; basically, any analyte molecule or particle that is able to be made to become immobilized with respect to (e.g., by binding) a capture component can be potentially investigated using the invention. Certain more specific targets of potential interest that may comprise an analyte molecule or particle are mentioned below. The list below is exemplary and non-limiting.

In some embodiments, the analyte molecule may be an enzyme. Non-limiting examples of enzymes include an oxidoreductase, transferase, kinase, hydrolase, lyase, isomerase, ligase, and the like. Additional examples of enzymes include, but are not limited to, polymerases, cathepsins, calpains, amino-transferases such as, for example, AST and ALT, proteases such as, for example, caspases, nucleotide cyclases, transferases, lipases, enzymes associated with heart attacks, and the like. When a system/method of the present invention is used to detect the presence of viral or bacterial agents, appropriate target enzymes include viral or bacterial polymerases and other such enzymes, including viral or bacterial proteases, or the like.

In other embodiments, the analyte molecule or particle may comprise an enzymatic component. For example, the analyte particle can be a cell having an enzyme or enzymatic component present on its extracellular surface. Alternatively, the analyte particle is a cell having no enzymatic component on its surface. Such a cell is typically identified using an indirect assaying method described below. A non-limiting example of an enzymatic component is beta-galactosidase.

In yet other embodiments, the analyte molecule may be a biomolecule. Non-limiting examples of biomolecules include hormones, antibodies, cytokines, proteins, nucleic acids, lipids, carbohydrates, lipids cellular membrane antigens and receptors (neural, hormonal, nutrient, and cell surface receptors) or their ligands, or combinations thereof. Non-limiting embodiments of proteins include peptides, polypeptides, protein fragments, protein complexes, fusion proteins, recombinant proteins, phosphoproteins, glycoproteins, lipoproteins, or the like. As will be appreciated by those in the art, there are a large number of possible proteinaceous analyte molecules that may be detected or evaluated for binding partners using the present invention. In addition to enzymes as discussed above, suitable protein analyte molecules include, but are not limited to, immunoglobulins, hormones, growth factors, cytokines (many of which serve as ligands for cellular receptors), cancer markers, etc.

In certain embodiments, the analyte molecule may be a host-translationally modified protein (e.g., phosphorylation, methylation, glycosylation) and the capture component may be an antibody specific to a post-translational modification. Modified proteins may be captured with capture components comprising a multiplicity of specific antibodies and then the captured proteins may be further bound to a binding ligand comprising a secondary antibody with specificity to a post-translational modification. Alternatively, modified proteins may be captured with capture components comprising an antibody specific for a post-translational modification and then the captured proteins may be further bound to binding ligands comprising antibodies specific to each modified protein.

In another embodiment, the analyte molecule is a nucleic acid. A nucleic acid may be captured with a complementary nucleic acid fragment (e.g., an oligonucleotide) and then optionally subsequently labeled with a binding ligand comprising a different complementary oligonucleotide.

Suitable analyte molecules and particles include, but are not limited to small molecules (including organic compounds and inorganic compounds), environmental pollutants (including pesticides, insecticides, toxins, etc.), therapeutic molecules (including therapeutic and abused drugs, antibiotics, etc.), biomolecules (including hormones, cytokines, proteins, nucleic acids, lipids, carbohydrates, cellular membrane antigens and receptors (neural, hormonal, nutrient, and cell surface receptors) or their ligands, etc), whole cells (including prokaryotic (such as pathogenic bacteria) and eukaryotic cells, including mammalian tumor cells), viruses (including retroviruses, herpesviruses, adenoviruses, lentiviruses, etc.), spores, etc.

The fluid sample comprising or suspected of comprising and analyte molecule or particle may be derived from any suitable source. In some cases, the sample may comprise a liquid, fluent particulate solid, fluid suspension of solid particles, supercritical fluid and/or gas. In some cases, the analyte molecule or particle may be separated or purified from its source prior to determination; however, in certain embodiments, an untreated sample containing the analyte molecule or particle may be tested directly. The source of the analyte molecule may be synthetic (e.g., produced in a laboratory), the environment (e.g., air, soil, etc.), a mammal, an animal, a plant, or any combination thereof. In a particular example, the source of an analyte molecule is a human bodily substance (e.g., blood, urine, saliva, tissue, organ, or the like).

According to certain embodiments of the invention, the fluid sample comprising the analyte molecules is placed in contact with an array of a plurality of reaction vessels. The array may be in contact with the fluid sample for at least about 1 second, at least about 1 minutes, at least about 2 minutes, at least about 5 minutes, at least about 10 minutes, at least about 30 minutes, at least about 1 hour, at least about 6 hours, at least about 12 hours, at least about 24 hours, at least about 48 hours, and the like. In a particular embodiment, the plurality of reaction vessels and sample are contacted for a period of from about 50 minutes to about 70 minutes. In another embodiment, the incubation period is about 1 hour. The period of time the sample is in contact with the plurality of reaction vessels may be varied depending on various parameters, for example, the concentration of the analyte molecule in the fluid sample. The period of incubation may be determined by determining the time which is required for an appropriate portion of the analyte molecules in a fluid sample to be immobilized with respect to the array. For example, the fluid sample may be incubated with the array such that about 50%, about 60%, about 70%, about 80%, about 90%, about 95%, about 97%, about 98%, about 99%, about 99.5%, about 99.9%, about 100%, and the like, of the analyte molecules are immobilized with respect to the array.

### Capture Components

In some embodiments of the present invention, the surfaces of the substrate may, as mentioned previously, incorporate at least one type of capture component. As mentioned above, a capture component is any molecule, other chemical/biological entity or solid support modification disposed upon a solid support that can be used to specifically attach, bind or otherwise capture a molecule or particle, such that the molecule or particle becomes immobilized with respect to the capture component and solid substrate. Generally, the capture component allows the attachment of a molecule, particle or complex to a solid support (that is, a surface of a substrate) for the purposes of immobilization, detection, quantification, and/or other analysis of the molecule, particle or complex. A capture component is used in the present invention, in some cases, to immobilize an analyte molecule with respect to the substrate. Those of ordinary skill in the art will be able to select appropriate capture component in accordance with the analyte molecules or particles to be immobilized.

As will be appreciated by those in the art, the composition of the capture component will depend on the composition of the analyte molecule. Capture components for a wide variety of target molecules are known or can be readily found using known techniques. For example, when the target molecule is a protein, the capture components may comprise proteins, particularly antibodies or fragments thereof (e.g., antigen-binding fragments (Fabs), Fab′ fragments, pepsin fragments, F(ab′)₂ fragments, full-length polyclonal or monoclonal antibodies, antibody-like fragments, etc.), other proteins, such as receptor proteins, Protein A, Protein C, etc., or small molecules. In some cases, capture components for proteins comprise peptides. For example, when the target molecule is an enzyme, suitable capture components may include enzyme substrates and enzyme inhibitors. In some cases, when the target analyte is a phosphorylated species, the capture component may comprise a phosphate-binding agent. For example, the phosphate-binding agent may comprise metal-ion affinity media such as those describe in U.S. Pat. No. 7,070,921 and U.S. Patent Application No. 20060121544. In addition, when the target molecule is a single-stranded nucleic acid, the capture component may be a complementary nucleic acid. Similarly, the target molecule may be a nucleic acid binding protein and the capture component may be a single-stranded or double-stranded nucleic acid; alternatively, the capture component may be a nucleic acid-binding protein when the target molecule is a single or double stranded nucleic acid. Alternatively, as is generally described in U.S. Pat. Nos. 5,270,163, 5,475,096, 5,567,588, 5,595,877, 5,637,459, 5,683,867, 5,705,337, and related patents, nucleic acid “aptamers” may be developed for capturing virtually any target molecule. As will be appreciated by those or ordinary skill in the art, any molecule that can specifically associate with a target molecule of interest may potentially be used as a capture component. For example, when the target molecule is a carbohydrate, potentially suitable capture components include, for example, antibodies, lectins and selecting.

For certain embodiments, suitable target molecule (e.g., analyte molecule)/capture component pairs can include, but are not limited to, antibodies/antigens, receptors/ligands, proteins/nucleic acid, nucleic acids/nucleic acids, enzymes/substrates and/or inhibitors, carbohydrates (including glycoproteins and glycolipids)/lectins and/or selecting, proteins/proteins, proteins/small molecules; small molecules/small molecules, etc. According to one embodiment, the capture components are portions (particularly the extracellular portions) of cell surface receptors that are known to multimerize, such as the growth hormone receptor, glucose transporters (particularly GLUT 4 receptor), and T-cell receptors and the target analytes are one or more receptor target ligands.

In a particular embodiment, the capture component may be attached to a binding surface (for example, the surface of a microwell or of a microbead) via a linkage, which may comprise any moiety, functionalization, or modification of the binding surface and/or capture component that facilitates the attachment of the capture component to the surface. The linkage between the capture component and the surface may comprise one or more chemical or physical (e.g., non-specific attachment via van der Waals forces, hydrogen bonding, electrostatic interactions, hydrophobic/hydrophilic interactions; etc.) bonds and/or chemical linkers providing such bond(s). In certain embodiments, the capture component comprises a capture extender component. In such embodiments, the capture component comprises a first portion that binds the analyte molecule and a second portion that can be used for attachment to the binding surface.

In certain embodiments, the substrate surface may also comprise a protective or passivating layer that can reduce or minimize non-specific attachment of non-capture components (e.g., analyte molecules, binding ligands) to the binding surface during the assay which may lead to false positive signals during detection or to loss of signal. Examples of materials that might comprise passivating layers include: polymers, such as poly(ethylene glycol), that repel the non-specific binding of proteins; naturally occurring proteins with this property, such as serum albumin and casein; zwitterionic surfactants, such as sulfobetaines; naturally occurring long-chain lipids; nucleic acids, such as salmon sperm DNA.

The method of attachment of the capture component to the substrate surface depends of the type of linkage employed and may potentially be accomplished by a wide variety of suitable coupling chemistries/techniques known to those of ordinary skill in the art. The particular means of attachment selected will depend on the material characteristics of the substrate surface and the nature of the capture component. In certain embodiments, the capture components may be attached to the substrate surface through the use of reactive functional groups on each. According to one embodiment, the functional groups are chemical functionalities. That is, the binding surface may be derivatized such that a chemical functionality is presented at the binding surface which can react with a chemical functionality on the capture component resulting in attachment. Examples of functional groups for attachment that may be useful include, but are not limited to, amino groups, carboxy groups, epoxide groups, maleimide groups, oxo groups and thiol groups. Functional groups can be attached, either directly or through the use of a linker, the combination of which is sometimes referred to herein as a “crosslinker.” Crosslinkers are known in the art; for example, homo- or hetero-bifunctional crosslinkers as are well known (e.g., see 1994 Pierce Chemical. Company catalog, technical section on crosslinkers, pages 155-200, or “Bioconjugate Techniques” by Greg T. Hermanson, Academic Press, 1996). Non-limiting example of crosslinkers include alkyl groups (including substituted alkyl groups and alkyl groups containing heteroatom moieties), esters, amide, amine, epoxy groups and ethylene glycol and derivatives. A linker may also be a sulfone group, forming a sulfonamide.

According to one embodiment, the functional group is a light-activated functional group. That is, the functional group can be activated by light to attach the capture component to the substrate surface. One example is PhotoLink™ technology available from SurModics, Inc. in Eden Prairie, Minn.

In some cases, the substrate may comprise streptavidin-coated surfaces and the capture component may be biotinylated. Exposure of the capture component to the streptavidin-coated surfaces may cause associated of the capture component with the surface by interaction between the biotin component and streptavidin.

In certain embodiments, attachment of the capture component to the binding surface may be effected without covalently modifying the binding surface of a substrate. For example, the attachment functionality can be added to the binding surface by using a linker that has both a functional group reactive with the capture component and a group that has binding affinity for the binding surface. In certain embodiments, a linker comprises a protein capable of binding or sticking to the binding surface; for example, in one such embodiment, the linker is serum albumin with free amine groups on its surface. A second linker (crosslinker) can then be added to attach the amine groups of the albumin to the capture component (e.g., to carboxy groups).

According to one embodiment in which a chemical crosslinker is used to attach the capture components to the substrate, the analyte molecule may be captured on the binding surface of a substrate using a capture component attached via chemical crosslinking in the following manner. First, the binding surface is derivatized with a functional group, such as, an amine group. Next, a crosslinker and the capture component are placed in contact with the binding surface such that one end of the crosslinker attaches to the amine group and the capture component attaches to the other end of the crosslinker. In this way, capture components comprising proteins, lectins, nucleic acids, small organic molecules, carbohydrates can be attached.

One embodiment utilizes proteinaceous capture components. As is known in the art, any number of techniques may be used to attach a proteinaceous capture component to a wide variety of solid surfaces. “Protein” or “proteinaceous” in this context includes proteins, polypeptides, peptides, including, for example, enzymes and antibodies. A wide variety of techniques are known to add reactive moieties to proteins, for example, the method outlined in U.S. Pat. No. 5,620,850. The attachment of proteins to surfaces is known, for example, see Heller, Acc. Chem. Res. 23:128 (1990), and many other similar references.

In some embodiments, the capture component (or binding ligand) may comprise Fab′ fragments. The use of Fab′ fragments as opposed to whole antibodies may help reduce non-specific binding between the capture component and the binding ligand. In some cases, the Fc region of a capture component (or binding ligand) may be removed (e.g., proteolytically). In some cases, an enzyme may be used to remove the Fc region (e.g., pepsin, which may produce F(ab′)₂ fragments and papain, which may produce Fab fragments). In some instances, the capture component may be attached to a binding surface using amines or may be modified with biotin (e.g., using NHS-biotin) to facilitate binding to an avidin or streptavidin coated substrate surface. F(ab′)₂ fragments may be subjected to a chemical reduction treatment (e.g., by exposure to 2-mercaptoethylamine) to, in some cases, form two thiol-bearing Fab′ fragments. These thiol-bearing fragments can them be attached via reaction with a Michael acceptor such as maleimide. Alternatively, the Fab′ fragments may then be treated with a reagent (e.g., maleimide-biotin) to attach at least one biotin moiety (i.e., biotinylated) to facilitate attachment to streptavidin-coated surfaces as described above.

Certain embodiments utilize nucleic acids as the capture component, for example for when the analyte molecule is a nucleic acid or a nucleic acid binding protein, or when it is desired that the capture component serve as an aptamer for binding a protein, as is well known in the art.

According to one embodiment, each binding surface of a substrate comprises a plurality of capture components. The plurality of capture components, in some cases, may be distributed randomly on the binding surface like a “lawn.” Alternatively, the capture components may be spatially segregated into distinct region(s) and distributed in any desired fashion.

Binding between the capture component and the analyte molecule, in certain embodiments, is specific, e.g., as when the capture component and the analyte molecule are complementary parts of a binding pair. In certain such embodiments, the capture component binds both specifically and directly to the analyte molecule. By “specifically bind” or “binding specificity,” it is meant that the capture component binds the analyte molecule with specificity sufficient to differentiate between the analyte molecule and other components or contaminants of the test sample. For example, the capture component, according to one embodiment, may be an antibody that binds specifically to some portion of an analyte molecule (e.g., an antigen). The antibody, according to one embodiment, can be any antibody capable of binding specifically to an analyte molecule of interest. For example, appropriate antibodies include, but are not limited to, monoclonal antibodies, bispecific antibodies, minibodies, domain antibodies, synthetic antibodies (sometimes referred to as antibody mimetics), chimeric antibodies, humanized antibodies, antibody fusions (sometimes referred to as “antibody conjugates”), and fragments of each, respectively. As another example, the analyte molecule may be an antibody and the capture component may be an antigen.

According to one embodiment in which an analyte particle is a biological cell (e.g., mammalian, avian, reptilian, other vertebrate, insect, yeast, bacterial, etc., cell), the capture component may be a ligand having specific affinity for a cell surface antigen (e.g., a cell surface receptor). In one embodiment, the capture component is an adhesion molecule receptor or portion thereof, which has binding specificity for a cell adhesion molecule expressed on the surface of a target cell type. In use, the adhesion molecule receptor binds with an adhesion molecule on the extracellular surface of the target cell, thereby immobilizing or capturing the cell. In one embodiment in which the analyte particle is a cell, the capture component is fibronectin, which has specificity for, for example, analyte particles comprising neural cells.

In some embodiments, as will be appreciated by those of ordinary skill in the art, it is possible to detect analyte molecules using capture components for which binding to analyte molecules that is not highly specific. For example, such systems/methods may use different capture components such as, for example, a panel of different binding ligands, and detection of any particular analyte molecule is determined via a “signature” of binding to this panel of binding ligands, similar to the manner in which “electronic noses” work. This may find particular utility in the detection of certain small molecule analytes. In some embodiments, the binding affinity between analyte molecules and capture components should be sufficient to remain bound under the conditions of the assay, including wash steps to remove molecules or particles that are non-specifically bound. In some cases, for example in the detection of certain biomolecules, the binding constant of the analyte molecule to its complementary capture component may be between at least about 10⁴ and about 10⁶ M⁻¹, between at least about 10⁵ and about 10⁹ M⁻¹, between at least about 10⁷ and about 10⁹ M⁻¹, greater than about 10⁹ M⁻¹, at least about 10⁷ M⁻¹, at least about 10⁸ M⁻¹, at least about 10⁹ M⁻¹.

In certain embodiments, the capture component is chosen to be able to bind to a corresponding binding partner associated with or attached to the analyte molecule For example, the capture component according to one embodiment is a chemical crosslinker as described above able to bind to proteins generally. According to one embodiment, every protein molecule in a fluid sample comprises an analyte molecule that attaches to such a chemical crosslinker. In another example, the capture component comprises streptavidin, which binds with high affinity to biotin, and thus captures any analyte molecules to which biotin has been attached. Alternatively, the capture component may be biotin, and streptavidin may be attached to or associated with the analyte molecules such that the analyte molecules can be captured by the biotin.

According to one embodiment, the binding surfaces of a substrate may be functionalized with capture components in the following manner. First, the surface of a substrate (e.g., the end of a fiber optic bundle) is prepared for attachment of the capture component(s) by being modified to form or directly bind to the capture components, or a linker may be added to the binding surface of the substrate such that the capture component(s) attaches to the binding surface of the substrate via the linker. In one embodiment, the binding surfaces of the substrate are derivatized with a chemical functionality as described above. Next, the capture component may be added, which binds to and is immobilized by the chemical functionality.

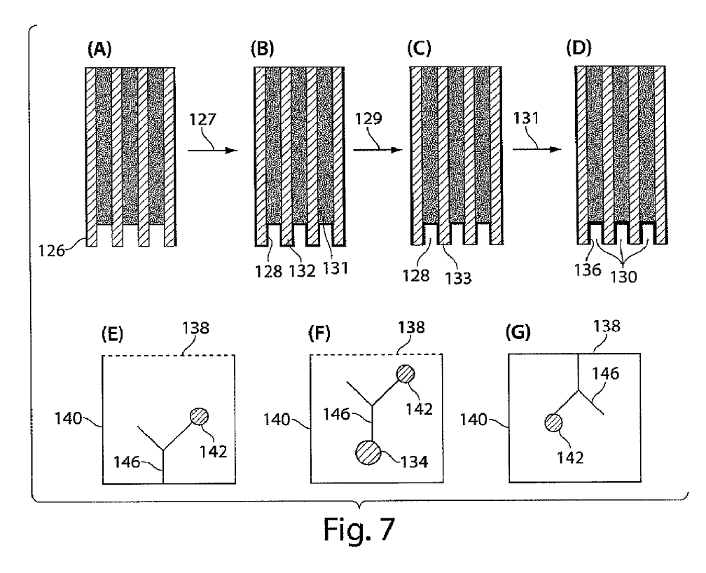

A specific embodiment is depicted in FIG. 7, in which the binding surface comprises an array of microwells functionalized with biotin. As shown in panel (A), an array of microwells 130 in this non-limiting example is formed at one end of a fiber optic bundle 126. To attach the capture component, the binding surface of the microwells 130 are first modified (e.g., with aminopropyl silane), as indicated by arrow 127, which may be bound to both the core 131 and cladding 132 surfaces of the distal end of the fiber bundle 126, as shown in FIG. 7, panel (B). However, in certain embodiments, the capture component should be present only within the microwells, the external surfaces of the fiber optic bundle, such as the external surfaces 133 of the cladding 132, should not be modified. In certain cases, after treatment, chemical functionalities may be removed from the external cladding surface 133 to avoid attachment of a capture component in this region. In this example, as shown in FIG. 7, panel (C), and as indicated by arrow 129, treated binding surface 128 may be removed from the external cladding portion 133, e.g., by polishing the tip of the fiber optical bundle (e.g., for 10 seconds with 0.3 μm lapping film), thereby removing the topmost layer of the cladding in this region, thereby removing the added binding moieties. After functionalization of the binding surface of the microwells, the capture component can be attached, as indicated by arrow 131 and shown in FIG. 7, panel (D). In one embodiment, the surface is treated with aminopropyl silane and the capture component comprises biotin or is labeled with biotin. For example, referring to FIG. 7, panel (D), a capture component comprising biotin succinimidyl ester 136 is attached to the amino groups of treated surface 128 of the microwells 130. The modification with aminopropyl silane is effective in this example because NHS-biotin attaches to an amino-silanized binding surface 128.

Examples of capture components 146 and exemplary association of capture components with an analyte molecule 142 within a reaction vessel 130 are depicted in FIG. 7, panels (E-G). A capture component 146 may be localized directly on the surface of the microwell 130, which may contain an optional seal 138, on a microparticle 134 contained within the microwell 130 (FIG. 7, panel (F)), and/or on the seal 138 of the microwell 130 (FIG. 7, panel (G)). Additional locations where a capture component may be immobilized and additional substrates that may be used for one or both of capturing an analyte molecule according to certain methods of the invention are discussed more below.

In some embodiments only a single analyte molecule associates with each capture component. However, in some instances, more than one analyte molecule may be immobilized with respect to each capture component. In yet other cases, a single analyte molecule may become immobilized with respect to two or more capture components (either of the same or differing types). In some cases, at least about 50%, at least about 60%, at least about 70%, at least about 80%, at least about 90%, at least about 95%, at least about 97%, at least about 99%, or more, of analyte molecules in the fluid sample exposed to the binding substrate become immobilized with respect to at least one capture component.

### Binding Ligands and Precursor Labeling/Labeling Agent Molecules

Binding ligands may be selected from any suitable molecule, particle, or the like, as discussed more below, able to associate with an analyte molecule and/or to associate with another binding ligand. For example, when only a first binding ligand is employed, a first binding ligand may associate with an analyte molecule. In another example, when a first binding ligand and a second binding ligand are employed, a first binding ligand may associate with an analyte molecule and a second binding ligand may become immobilized with respect to the analyte molecule by becoming associated with the first binding ligand. Some non-limiting examples of potentially suitable binding ligands are discussed more below.

Certain binding ligands can comprise a component that is able to facilitate detection, either directly or indirectly. A component may facilitate indirect detection, for example, by converting a precursor labeling agent molecule into a labeling agent molecule (e.g., an agent that is directly or indirectly detected in an assay). In some embodiments, the binding ligand may comprise an enzymatic component. In some cases, a plurality of types of binding ligands may be employed, for example, a first binding ligand and a second binding ligand. In some cases, at least one, at least two, at least three, at least four, at least five, or the like, types of binding ligands may be employed. In some embodiments, at least one binding ligand employed in the assay may comprise a converting agent. A precursor labeling agent molecule upon exposure to a converting agent is converted to a labeling agent molecule (e.g., a detectable product), examples of which are discussed herein.

As mentioned above, a precursor labeling agent molecule is any molecule, particle, or the like, that can be converted to a labeling agent molecule upon exposure to a suitable binding ligand (e.g. a binding ligand comprising a converting agent able to convert the precursor labeling agent). In some embodiments, a labeling agent molecule is insoluble (such that it can form a detectable precipitate) and/or immobilized with respect to the reaction vessel. In some case, a labeling agent molecule may be detected directly (e.g., the labeling agent molecule produces a detectable signal, constitutively and/or in response to an external simulation), for example, the labeling agent molecule form a precipitate (e.g., be insoluble), fluorogenic, chromogenic, chemiluminescent, or the like. In other cases, the labeling agent molecule may be detected indirectly (e.g., the labeling agent molecule converts another particle, molecule, or the like into a detectable entity, or immobilizes or captures another agent which is directly or indirectly detectable), as discussed more herein.

In some cases, the precursor labeling agent molecule may be solubilized or suspended in a fluid, such as a liquid. For embodiments where the fluid is a liquid, the liquid may comprise any suitable liquid, and/or more than one type of liquid, and may be selected according to its properties. For example, the liquid may be substantially hydrophobic or substantially hydrophilic, substantially viscous or substantially non-viscous, substantially polar or non-polar, or the like. Non-limiting examples of liquids include water, alcohols (e.g., methanol, ethanol, propanol, isopropanol, butanol, etc.), hydrocarbons (e.g., pentane, hexane, heptane, etc.), organic solvents (e.g., toluene, benzene, etc.), ethers (e.g., diethyl ether, tetrahydrofuran), dimethylsulfoxide, acetone, acetic acid, or the like. The precursor labeling agent molecule may have a solubility of greater than about 1×10⁻⁶ M, greater than about 1×10⁻⁵M, greater than about 1×10⁻⁴ M, greater than about 1×10⁻³ M, greater than about 1×10⁻² M, greater than about 1×10⁻¹ M, greater than about 1 M, greater than about 10 M, or greater.

In some embodiments, the labeling agent molecule is insoluble. That is, the precursor labeling agent molecule is converted to a product which is insoluble in the liquid in which the labeling agent molecule is contained. In some cases, the labeling agent molecule has a solubility of less than 1×10⁻¹ M, less than 1×10⁻² M, less than 1×10⁻³ M, less than 1×10⁻⁴ M, less than 1×10⁻⁵ M, less than 1×10⁻⁶ M, less than 1×10⁻⁷ M, less than 1×10⁻⁸ M, less than 1×10⁻⁹ M, less than 1×10⁻¹⁰ M, less than 1×10⁻¹² M, less than 1×10⁻¹⁵ M, less than 1×10⁻²⁰ M, less than 1×10⁻³⁰ M, or less.

In some embodiments, binding ligands and precursor labeling agents may be selected such that are able to function in the following manner. In some cases, if only a first binding ligand is employed, the first binding ligand may associate with an analyte molecule and may comprise a component which converts a precursor labeling agent molecule into a labeling agent. In other cases, if both a first and a second binding ligand are employed, the first binding ligand may associate with an analyte molecule and comprise a component which is able to interact with the second binding ligand. The second binding ligand may associate with the first binding ligand. At least one of the first and second binding ligand may comprise a converting agent which is able to convert a precursor labeling agent molecule into a labeling agent molecule. The assay may also comprise additional components (e.g., a third binding ligand, labeling agent capture components, etc.), and these additional components may be selected for particular desired functionality (e.g., a third binding agent selected such that it associates with an second binding ligand which is associated with a first binding ligand which is associated with an analyte molecule or particle, etc.). Any assay component may be selected such that it is able to associate with other assay component(s) as outlined above. In some cases, an assay component may be able to associate with more than one other assay component, for example, a third binding ligand may associate with both a first and a second binding ligand. The binding constant of the analyte molecule or particle with a binding ligand and/or the binding constant between two types of binding ligands may be at least about 10⁴ M⁻¹, at least about 10⁵ M⁻¹, at least about 10⁶ M⁻¹, at least about 10⁷ M⁻¹, at least about 10⁸ M⁻¹, at least about 10⁹ M⁻¹, between about 10⁴ M⁻¹ and about 10⁹ M⁻¹, greater than about 10⁹ M⁻¹, or greater.

In some cases, at least one binding ligand may comprise biotin and/or streptavidin. As a non-limiting example, the first binding ligand may be a biotinylated detection antibody, wherein the antibody may associate with an analyte molecule. The second binding ligand may be a streptavidin conjugated with a converting agent (e.g., an enzyme such as horseradish peroxidase), wherein the streptavidin of the second binding ligand will associate with the biotin of the first binding ligand. The converting agent of the second binding ligand may convert a precursor labeling agent molecule into a labeling agent molecule.

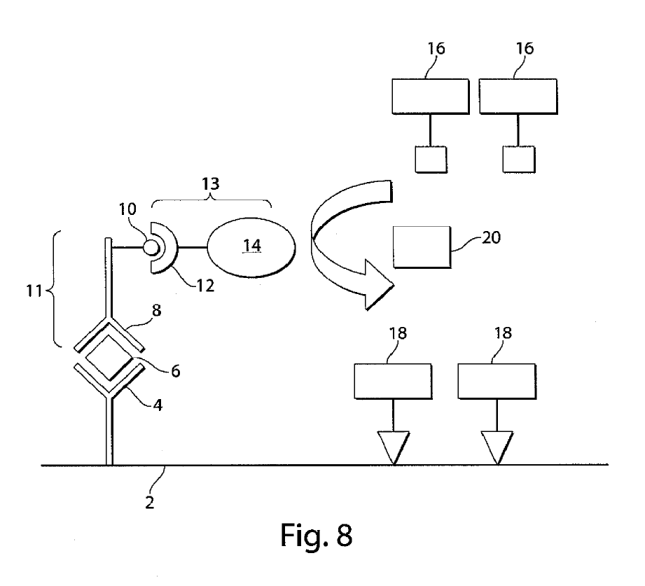

A non-limiting embodiment is illustrated in FIG. 8. Reaction vessel 2 comprises a capture component 4 to which analyte molecule 6 associates. Reaction vessel 2 is exposed to first binding ligand 11 which comprises biotin 10 and component 8 which associates with analyte molecule 6. Reaction vessel 2 is also exposed to second binding ligand 13 which comprises streptavidin 12, which associates with biotin from first binding ligand 11, and converting agent 14, which converts precursor labeling agent molecule 16 into labeling agent molecule 18, as indicated by arrow 20.

In some embodiments, at least one binding ligand may comprise a converting agent which facilitates the conversion of a precursor labeling agent molecule into a labeling agent molecule. Non-limiting examples of converting agents include an enzymatic component, a nanoparticle, etc., as discussed more herein.

In some embodiments, at least one binding ligand employed in certain embodiments of the present invention may comprise an enzymatic component as a converting agent. In this instance, the precursor labeling agent molecule may be an enzymatic substrate, for example, a chromogenic, fluorogenic, or chemiluminescent enzymatic substrate, that upon contact with the enzymatic component of the binding ligand, converts to a detectable product. In some cases, the detectable product is insoluble and/or immobilized in the reaction vessel. In some cases, the enzymatic substrate is provided in an amount sufficient to contact every binding ligand associated with an analyte molecule which was partitioned across a plurality of reaction vessels. In some embodiments, the presence of a detectable produce (e.g., a chromogenic, fluorogenic, or chemiluminescent product) in a reaction vessel may provide information about the identity and/or concentration of an analyte molecule in the fluid sample based on the interaction of the analyte molecule with the capture component and the binding ligand, as described herein. Non-limiting examples of enzymatic components that may be employed include beta-galactosidase and horseradish peroxidase.

As will be understood by those of ordinary skill in the art, enzymatic precursor labeling agent molecules may be selected for conversion by many different enzymes. Thus, any known chromogenic, fluorogenic, or chemiluminescent enzyme precursor labeling agent molecule capable of producing a detectable product in a reaction with a particular enzyme can potentially be used in the present invention as the precursor labeling agent molecule in embodiments where at least one binding ligand comprises an enzymatic component. For example, many chromogenic, fluorogenic, or chemiluminescent precursor labeling agent molecules suitable for use an enzymatic precursor labeling agent molecule are disclosed in The Handbook—A Guide to Fluorescent Probes and Labeling Technologies, Tenth Ed., Chapter 10.

A specific example of an enzymatic component for a binding ligand is horseradish peroxidase (HRP). HRP is a common enzymatic component for various assays and is known to those of ordinary skill in the art. HRP may be the enzymatic component of a binding ligand, wherein the binding ligand may also be capable of associating with an analyte molecule, another binding ligand, etc. As a non-limiting example, a binding ligand may be an HRP-labeled antibody or streptavidin conjugate, wherein the analyte molecule is an antigen. In some cases, HRP may convert a precursor labeling agent molecule into a labeling agent molecule that is insoluble and precipitates in the reaction vessel. Many examples include those typically used in Western blotting applications such as chloronapthol and/of diaminobenzidine, as known to those commonly skilled in the art. In some instances, the precipitate will be a darkly colored molecule and the precipitate may be detected optically. For example, the darkly colored molecules may be detected using light as the precipitate may block transmission of light through the well.

A binding ligand that comprises an enzymatic component (e.g., HRP) may be used jointly with a precursor labeling agent molecule (e.g., enzymatic substrate) that may be immobilized and/or insoluble when converted to a labeling agent molecule (e.g., detectable product). For example, HRP in the presence of hydrogen peroxide catalyzes the conversion of tyramide into an activated tryamide that can become immobilized with respect to materials (e.g. glass) of certain reaction vessels. In some embodiments, a tyramide molecule may be attached to any variety of molecules or particles that facilitate detection. For example, a tryamide molecule may be attached to a dye (e.g., a fluorescent dye). Therefore, the presence of the dye in a reaction vessel can be used to detect the presence of an analyte molecule in a reaction vessel. In some cases, the conversion of tyramide to activated tyramide may cause a component associated with the tyramide to become detectable (e.g., may cause a non-fluorescent component to fluoresce upon activation).

An exemplary embodiment is illustrated in FIG. 8. Reaction vessel 2 comprises a capture component 4 with which analyte molecule 6 associates. Reaction vessel 2 is exposed to first binding ligand 11 which comprises component 10 and component 8 which associates with analyte molecule 6. Reaction vessel 2 is also exposed to second binding ligand 13 which comprises component 12, which associates with component 10 from first binding ligand 11, and HRP 14, which converts precursor tyramide 16 (precursor labeling agent) into an activated tyramide 18 (labeling agent), as indicated by arrow 20. The activated tyramide may precipitate in the reaction vessel and/or may associate with a labeling agent capture component in the reaction vessels. The activated tyramide may be detected directed (e.g., if a precipitate or if the activated tyramide comprises a detectable component) or indirectly (e.g., if the activated tyramide comprises a component (e.g., an enzymatic component) which is able to convert a labeling agent reactant into a detectable product).

In other instances, the precursor labeling agent molecule may be used in conjunction with a labeling agent reactant (e.g., FIGS. 3B and 3D, as discussed herein). For example, the precursor labeling agent molecule may comprise tyramide and a component which is able to convert a labeling agent reactant into a detectable product or is able to associate with a labeling agent reactant which is detectable. For example, a tyramide molecule may be associated with biotin. A reaction vessel may be exposed to fluorescently-labeled streptavidin which may associate with the biotin and is able to be detected directly. In other cases, a tyramide molecule may comprise an enzymatic component. The enzymatic component (e.g., streptavidin-beta-galactosidase) may be exposed to a labeling agent reactant (e.g., an enzymatic substrate) which may be converted to a detectable product.

In yet other instances, the precursor labeling agent molecule may be used in conjunction with a first and a second labeling agent reactant (e.g., FIG. 3C, as discussed herein). For example, the precursor labeling agent molecule may comprise tyramide and a component (e.g., biotin) which is able to associate with a first labeling agent reactant (e.g., an enzymatic component). The second labeling agent reactant (e.g., an enzymatic substrate) may be converted to a detectable product upon exposure to the first labeling agent reactant which is associated with the labeling agent molecule.

Other examples materials that may be utilized as enzymatic components, precursor labeling agent molecules and labeling agent reactants will become apparent to those commonly skilled in the art with the guidance of the present disclosure. As specific examples, HRP may activate a labeled tyramide derivative such as a fluorescent or biotinylated tyramide, hapten-conjugated tyramides, or tyramide labeled with polymeric reagents (e.g., tyramide-conjugated gold particles). Many kits comprising the reagents mentioned above may be purchased from commercial sources.

It is to be understood that a wide variety of labeling agents/detectable products can be used in the practice of the methods described herein For example, it is understood that a variety of colored labels (for example, metallic nanoparticles (for example, gold nanoparticles), semiconductor nanoparticles, semiconductor nanocrystals (for example, quantum dots), spectroscopic labels (for example, fluorescent labels), radiolabels, and enzymatic labels may be used, in the practice of the invention.

In some embodiments, a binding ligand may comprise a nanoparticle, for example, a gold nanoparticle. In this embodiment, the precursor labeling agent molecule may be a material that can associate with the binding ligand (e.g., the nanoparticle) upon conversion to a labeling agent. For example, metal particles may nucleate the highly specific deposition of metal (e.g., silver) from an appropriate metal salt solution in the presence of a suitable reducing agent. In this way, the nanoparticle may be coated in another metal such that the size of the nanoparticle increases and may be detected to determine the presence or absence of an analyte molecule or particle in a reaction vessel. Various techniques, such as electroless deposition, may be employed to make visible particles. In other instances, the nanoparticle may convert the precursor labeling agent molecule into a labeling agent molecule that is immobilized with respect to the reaction vessel or is insoluble. In a specific example, the first binding ligand comprises a gold nanoparticle. In this example, the precursor labeling agent molecule may be a silver salt that in the presence of a reducing agent forms a silver coating on the gold nanoparticle. Functionalization of a component that acts as a binding ligand in the inventive assays will be known to those skilled in the art and many kits and nanoparticle labeled antibodies and the like are commercially available to facilitate functionalization. Molecules, solutions, compounds and the like that may function as precursor labeling agents for deposition on a gold particle to form a labeling agent are also be known to those skilled in the art and are commercially available.

In some embodiments, the plurality of reaction vessels may additionally comprise at least one labeling agent molecule capture component. As describe above, a labeling agent molecule capture component is a capture component that specifically binds to or otherwise captures a labeling agent molecule, such that the labeling agent molecule is immobilized during the assay. Generally, the labeling agent molecule capture component allows the attachment of a labeling agent molecule to a solid support (e.g., the surface of a microwell, a sealing component or a nanoparticle in a reaction vessel) for the purposes of detection, quantification, or other analysis. The labeling agent molecule capture component may or may not be the same as a capture component present in a reaction vessel which is used to capture the analyte molecules. In such instances, of the plurality of capture components in a reaction vessel, at least one capture component may capture an analyte molecule, and the remainder of the capture components would be available to capture labeling agent molecules. In some cases, a method of the present invention will comprise the step of immobilizing at least a portion of the labeling agent molecules with respect to the at least one labeling agent molecule capture component.

In some embodiments, a functional group or other entity facilitating attachment of an analyte capture component to a surface may function as the labeling agent molecule capture component. For example, the plurality of reaction vessels may be functionalized with functional group or other entity facilitating attachment of an analyte capture component to a surface, and at least some of the functional groups/entities may be attached to a capture component and at least some of the groups/entities may remain unattached to analyte capture components. The groups/entities that are not coupled to analyte capture components may act as a labeling agent molecule capture components. For example, in some cases, the entity may comprise biotin and the biotin may also act as a labeling agent molecule capture component, for example, when a precursor labeling agent molecule is converted to a labeling agent molecule that comprises a component that associates with biotin (e.g., activated tyramide or streptavidin).

### Detection Methods

In some embodiments, in the systems/methods in which the analyte molecules to be detected are partitioned across a plurality of reaction vessels, the reaction vessels may be interrogated using a variety of techniques, including techniques known to those of ordinary skill in the art.

In a specific embodiment of the present invention, reaction vessels are optically interrogated. The reaction vessels exhibiting changes in their optical signature may be identified by a conventional optical train and optical detection system. Depending on the labeling agent molecules detected and the operative wavelengths, optical filters designed for a particular wavelength may be employed for optical interrogation of the reaction vessels. In one embodiment, the plurality of reaction vessels of the present invention is formed directly as part of a fiber optic bundle.

According to one embodiment, the array of reaction vessels of the present invention can be used in conjunction with an optical detection system such as the system described in U.S. Publication No. 20030027126. For example, according to one embodiment, the array of reaction vessels of the present invention is formed in one end of a fiber optic assembly comprising a fiber optic bundle constructed of clad fibers so that light does not mix between fibers.

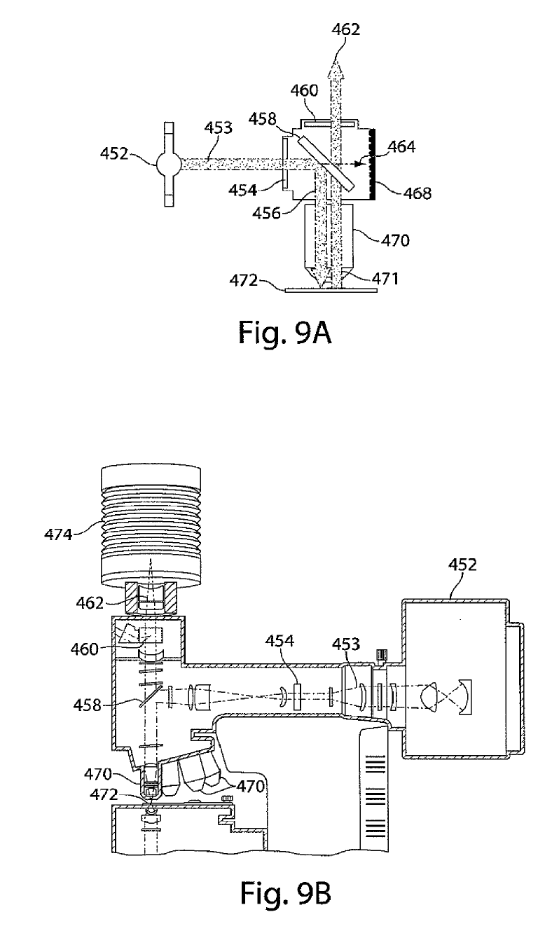

FIG. 9A shows a non-limiting example of a system of the present invention according to some embodiments. The system comprises a light source 252, excitation filter 454, dichromatic mirror 458, emission filter 460, objective 470, and substrate 472. Light 453 may be given from light source 452 and passed through excitation filter 454. The light may reflect off dichromatic mirror 458, pass through objective 470 and shine on substrate 472. In some cases, stray light 464 may be reduced by stray light reducing function 468. Light 471 emitted from substrate passes through objective 472 and emission filter 460 and is observed. The system may comprise additional component (e.g., additional filters, mirrors, magnification devices, etc.), as will be understood by those of ordinary skill in the art.

The optical detection system of U.S. Publication No. 20030027126 operates as follows. Light returning from the distal end of the fiber optic bundle is passed by the attachment to a magnification changer which enables adjustment of the image size of the fiber's proximal or distal end. Light passing through the magnification changer is then shuttered and filtered by a second wheel. The light then is imaged on a charge coupled device (CCD) camera. A computer executes imaging processing software to process the information from the CCD camera and also optionally controls the first and second shutter and filter wheels. As depicted in U.S. Publication No. 20030027126, the proximal end of the bundle is received by a z-translation stage and x-y micropositioner.

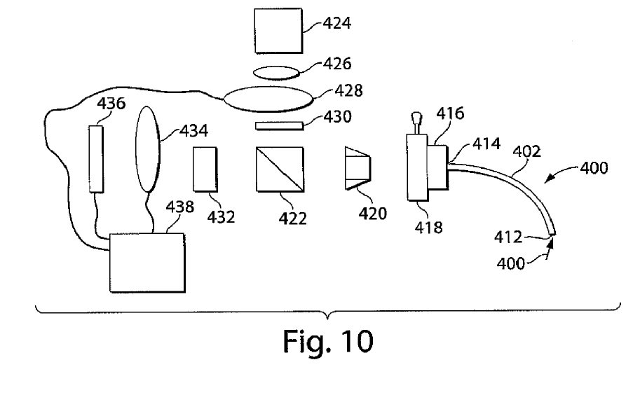

For example, FIG. 10 shows a schematic block diagram of a system employing a fiber optic assembly 400 with an optical detection system. The fiber optic assembly 400 comprises a fiber optic bundle or array 402 that is constructed from clad fibers so that light does not mix between fibers. An array or system, 400 is attached to the bundle's distal end 412, with the proximal end 414 being received by a z-translation stage 416 and x-y micropositioner 418. These two components act in concert to properly position the proximal end 414 of the bundle 402 for a microscope objective lens 420. Light collected by the objective lens 420 is passed to a reflected light fluorescence attachment with three pointer cube slider 422. The attachment 422 allows insertion of light from a 75 Waft Xe lamp 424 through the objective lens 420 to be coupled into the fiber bundle 402. The light from the source 424 is condensed by condensing lens 426, then filtered and/or shuttered by filter and shutter wheel 428, and subsequently passes through a ND filter slide 430. Light returning from the distal end 412 of the bundle 402 is passed by the attachment 422 to a magnification changer 432 which enables adjustment of the image size of the fiber's proximal or distal end. Light passing through the magnification changer 432 is then shuttered and filtered by a second wheel 434. The light is then imaged on a charge coupled device (CCD) camera 436. A computer 438 executes imaging processing software to process the information from the CCD camera 436 and also possibly control the first and second shutter and filter wheels 428, 434.

The array of reaction vessels in certain embodiments of the present invention may be integral with or attached to the end of the fiber optic bundle using a variety of compatible processes. In some cases, microwells are formed at the center of each individual fiber of the fiber optic bundle and the microwells may or may not be sealed. Each optical fiber of the fiber optic bundle may convey light from the single microwell formed at the center of the fiber's end. This feature enables the interrogation of the optical signature of individual reaction vessels to identify reactions/contents in each microwell. Consequently, by imaging the end of the bundle onto the CCD array, the optical signatures of the reaction vessels are individually interrogatable and may be detected substantially simultaneously.

In some embodiments, the methods of the present invention may be performed with or without sealing of the array of reaction vessels. In some cases, there may be substantially no difference between as assay performed with sealing the array and an assay performed using essentially identical conditions without sealing of the array. Without wishing to be bound by theory, this may be attributed to the insolubility and/or immobilization of labeling agent molecules in the reaction vessels (e.g., such that the labeling agent molecule is unable to diffuse into adjacent reaction vessels and thus additional reaction vessels would comprise a detectable product) provided by certain embodiments of the invention. In other cases, it may be attributed to the direct detection of a detectable molecule (e.g., an insoluble labeling agent molecule). For example, in instances where amplification is not employed (e.g., direct detection of a labeling agent molecule, as opposed to further exposure and detection of a labeling agent reactants, a second labeling agent molecule, etc.), there may be no species (e.g., labeling agent reactants, etc.) which diffuse to neighboring reaction vessels and cause additional reaction vessels to comprise a detectable product.

In embodiments where the plurality of reaction vessels are sealed, the plurality of reaction vessels may be sealed, for example, through the mating of the substrate and a sealing component. In some cases, the sealing of the reaction vessels may be such that the contents of each reaction vessel cannot escape the reaction vessel. In some cases, the reaction vessels may be sealed after the addition of a binding ligand and, optionally, a precursor labeling agent molecule to facilitate detection of the analyte molecules. For embodiments employing precursor labeling agent molecules, by sealing the contents in some of each reaction vessel, a reaction to produce the detectable labeling agent molecule can proceed within the sealed reaction vessels, thereby producing a detectable amount of a labeling agent molecule that is retained in the reaction vessel for detection purposes.

In some embodiments, at least a fraction of the number of detectable species (e.g., labeling agent molecules) may be detected substantially simultaneously. “Substantially simultaneously” when used in conjunction with detection, as used herein, refers to detection of the species/molecules/particles of interest at approximately the same time, as opposed to sequentially detected. A plurality of molecules/particles (e.g., labeling agent molecules, labeling agent reactants, etc.) may be detected substantially simultaneously using various techniques, including optical techniques (e.g., CCD detector).

### Quantification

According to certain embodiments of the present invention, certain methods, systems, and devices disclosed can be used to detect the presence of an analyte molecule and/or determine the concentration of analyte molecules in a fluid sample. In some cases, there is a correlation between the percentage of reaction vessels containing one or more analyte molecules or particles and the concentration of the analyte molecules in the fluid sample. Thus, the quantification method of certain embodiments of the present invention allows for calculation of the number of analyte molecules in a fluid sample based on the percentage of reaction vessels that contain an analyte molecule. In some embodiments, the measure of the concentration of analyte molecules in a fluid sample will be determined using a calibration curve. Methods to determine a measure of the concentration of analyte molecules in a fluid sample are discussed more below.

Certain embodiments of present invention are distinguished by the ability to detect and/or quantify low numbers/concentrations of analyte molecules or particles in a fluid sample. It is currently believed that this ability may be achieved by spatially isolating individual or small numbers of analyte molecules or particles, for example, as when they are partitioned across an array of reaction vessels, and then detecting their presence in the reaction vessels. The presence of an analyte molecules or particles in a reaction vessel can be counted in a binary fashion (e.g., zero when an analyte molecule is absent; one when an analyte molecule is present), for example by determining the presence of a detectable molecule or particle (e.g. a labeling agent) in a reaction vessel that contains at least one analyte molecule or particles.

In some embodiments, the plurality of analyte molecules (or particles) may be partitioned such that at least some of the reaction vessels contain no analyte molecules and at least some of reaction vessels contain at least one or, in certain cases, only one analyte molecule. For example, in some cases, the plurality of analyte molecules (or particles) may be partitioned such that a statistically significant fraction of the reaction vessels contain no analyte molecules and a statistically significant fraction of reaction vessels contain at least one analyte molecule. In other cases, the plurality of analyte molecules may be partitioned such that a statistically significant fraction of the reaction vessels contain no analyte molecules and a statistically significant fraction of reaction vessels contain only one analyte molecule. In either case, the number of the plurality of reaction vessels and/or fraction of the plurality of reaction vessels that contain or do not contain an analyte molecule may be determined. The number and/or fraction of the plurality of reaction vessels that contain an analyte molecule can be related to the concentration of analyte molecules or particles in the sample. In some embodiments, a measure of the concentration of analyte molecules or particles in the fluid sample is determined based on the determination of the number and/or fraction of the plurality of reaction vessels that contain an analyte molecule. In certain such embodiments, the measure of the concentration of the analyte molecules or particles in the fluid sample is determined at least in part comparison of a measured parameter to a calibration standard and/or by a Poisson and/or Gaussian distribution analysis of the number or fraction of the plurality of reaction vessels that contain an analyte molecule, as discussed more below. A “statistically significant fraction” of the reaction vessels that contain a specified quantity of dissociated species is defined as the minimum number of reaction vessels that can be reproducibly determined to contain an analyte molecule or particle with a particular system of detection (i.e., substantially similar results are obtained for multiple essentially identical fluid samples comprising the target analyte molecule) and that is above the background noise (e.g., non-specific binding) that is determined when carrying out the assay with a sample that does not contain any analyte molecules or particles, divided by the total number of reaction vessels. The statistically significant fraction may be experimentally determined for a certain assay type and equipment set up (e.g., for each analyte molecule determined, each binding ligand, etc). In certain embodiments, the percentage of reaction vessels (e.g., the statistically significant fraction) which comprises only one or at least one analyte molecule or particle is less than about 10%, less than about 5%, less than about 1%, less than about 0.5%, or less than about 0.1% of the total reaction vessels. In some cases, the percentage of reaction vessels which do not contain an analyte molecule or particle is at least about 20%, at least about 40%, at least about 50%, at least about 60%, at least about 70%, at least about 75%, at least about 80%, at least about 90%, or at least about 95%, at least about 99%, at least about 99.5%, at least about 99.9%, or greater, of the total number of reaction vessels.

In some embodiments, a measure of the concentration of analyte molecules or particles in the fluid sample may be determined at least in part by comparison of a measured parameter to a calibration standard. For example, the fraction of reaction vessels that comprise an analyte molecule may be compared against a calibration curve to determine a measure of the concentration of the analyte molecule in the fluid sample. The calibration curve may be produced by completing the assay with a plurality of standardized samples of known concentration under the conditions used to analyze the test samples. A reading may be taken for the signal related to the detection/quantification of the analyte molecules for each standardized sample, therefore allowing for the formation of a calibration curve relating the detection of the analyte molecules with a known concentration of the analyte molecule. The assay may then be completed on a sample comprising the analyte molecule in an unknown concentration, and the detection of the analyte molecules from this assay may be plotted on the calibration curve, therefore determining a measure of the concentration of the analyte molecule in the fluid sample.

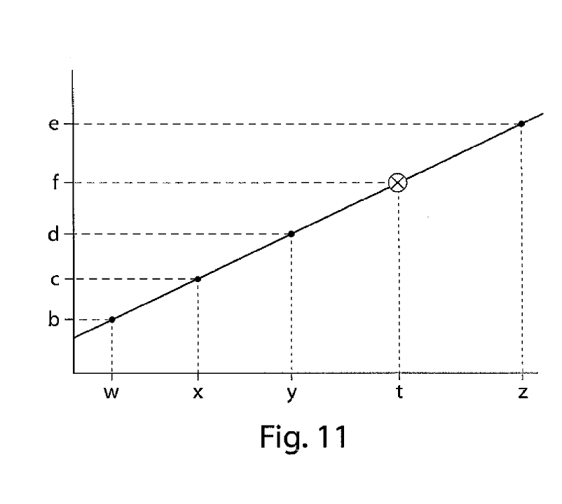

In one exemplary calibration (see FIG. 11), four standardized fluid samples comprising an analyte molecule in varying concentration (w, x, y, and z) are provided. An assay (e.g., immobilizing the analyte molecules, detecting the presence of at least a portion of the immobilized analyte molecules) is carried out for each sample, and a value corresponding to the detection of the analyte molecules (b, c, d, and e) may be determined. A plot is produced of the values related to detection of the analyte molecules (b, c, d, and e) versus the concentration of the standardized samples (w, x, y, and z), as depicted in FIG. 11. The assay may be then be carried out under substantially identical conditions on a fluid sample comprising an analyte molecule of unknown concentration t, wherein the resulting value related to detection of the analyte molecules is f. This value is plotted on the graph and a measure of the unknown concentration of the target analyte in the fluid sample may be interpolated from the values of the standardized samples. In some cases, the calibration curve may have a limit of detection, wherein the limit of detection is the lowest concentration of analyte molecules in a fluid sample that may be accurately determined. In some cases, the r² value of the calibration curve may be greater than about 0.5, greater than about 0.75, greater than about 0.8, greater than about 0.9, greater than about 0.95, greater than about 0.97, greater than about 0.98, greater than about 0.99, greater than about 0.9999, or about 1.

In some embodiments, the calibration curve and/or the calculation of concentration of the analyte molecules in the fluid sample based on a calibration curve may be stored and/or determined with a system comprising a computer. The computer may comprise software that may use the data collected to produce the calibration curve and/or a determination of the measure of the concentration of the analyte molecules in the fluid sample. For example, a fluorescence image of an array comprising the analyte molecules partitioned across the array (e.g., reaction vessels formed in an optical fiber bundle) may be collected and analyzed using image analysis software (e.g., IP Lab, BD Biosciences). The analysis software may automatically segment all reaction vessels that have fluorescence intensity over the background intensity and give a number indicative of the total number of reaction vessel which comprise fluorescent intensity above background (e.g., a number that correlates to the number of reaction vessels which comprise an analyte molecule). The number of reaction vessels which comprise fluorescence intensity above background may be divided by the total number of reaction vessels addressed to give a number correlating to the fraction of reaction vessels which comprise an analyte molecule. The active well fraction may be compared to a calibration curve to determine a measure of the concentration of analyte molecules in the fluid sample.

In some cases, the number of analyte molecules that are detected may or may not be approximately equal to the number of analyte molecules in the fluid sample. For example, the ratio of analyte molecules detected in the fluid sample to analyte molecules which are detected may be about 1:1, about 2:1, about 5:1, about 10:1, about 100:1, about 1000:1, about 10000:1, or the like. In some cases, the ratio is greater than about 1:1, greater than about 10:1, great than about 100:1, greater than about 1000:1, greater than about 10000:1, or greater.

In some embodiments, the concentration of analyte molecules or particles in the fluid sample that may be substantially accurately determined is less than about 5000 fM, less than about 3000 fM, less than about 2000 fM, less than about 1000 fM, less than about 500 fM, less than about 300 fM, less than about 200 fM, less than about 100 μm, less than about 50 fM, less than about 25 fM, less than about 10 fM, less than about 5 fM, less than about 2 fM, less than about 1 fM, less than about 0.5 μm, less than about 0.1 fM, or less. In some embodiments, the concentration of analyte molecules or particles in the fluid sample that may be substantially accurately determined is between about 5000 fM and about 0.1 fM, between about 3000 fM and about 0.1 fM, between about 1000 fM and about 0.1 fM, between about 1000 fM and about 1 fM, between about 100 fM and about 1 fM, between about 100 fM and about 0.1 fM. The concentration of analyte molecules or particles in a fluid sample may be considered to be substantially accurately determined if the measured concentration of the analyte molecules or particles in the fluid sample is within about 10% of the actual concentration of the analyte molecules or particles in the fluid sample. In certain embodiments, the measured concentration of the analyte molecules or particles in the fluid sample may be within about 10%, within about 7%, within about 5%, within about 4%, within about 3%, within about 2%, within about 1%, within about 0.5%, within about 0.4%, within about 0.3%, within about 0.2% or within about 0.1%, of the actual concentration of the analyte molecules or particles in the fluid sample. The accuracy of the assay method may be determined, in some embodiments, by determining the concentration of analyte molecules in a fluid sample of a known concentration using the selected assay method.

Without being limited by theory, the quantification method is believed to be driven in part by the fact that the number and volume of reaction vessels employed govern the dynamic range of concentrations that can be determined. That is, based on the number and volume of the reaction vessels in an array of the present invention, an estimate can be made of the range of concentrations of detected molecules in the solution partitioned across the vessels that allows for a measure of the concentration to be determined using certain methods of the present invention.

For example, for an array comprising approximately 2.4×10⁵ reaction vessels, each having a volume of approximately 50 fL, a solution having a concentration of approximately 4×10⁻¹¹ M analyte molecules in a fluid sample will yield, on average, one analyte molecule per reaction vessel. However, it is important to note that distributing a fluid sample having an analyte molecule concentration within the appropriate range into an array of reaction vessels will not result in the distribution of exactly one analyte molecule per each reaction vessel; statistically, some vessels will have multiple analyte molecules while others will have no analyte molecules. In the case where the ratio of vessels containing one or more analyte molecules to the number of vessels containing no analyte molecules is high, the data may be fit to a Gaussian distribution. As the ratio of reaction vessels containing an analyte molecule to the number of vessels containing no analyte molecules approaches zero, the Poisson distribution may be applied to the data. This limiting distribution may be used to calculate the probability of rare events occurring in a large number of trials. For example, based on Poisson statistics, for a concentration of approximately 4×10⁻¹¹ M, a distribution between zero and five analyte molecules per reaction vessel is predicted, with the most probable values being zero and one.

Equation 1 can be used to determine the probability of observing events based on the expected average number of events per trial, μ:

Pμ(v)=e^{-μ}(μ^{v}/v!) Equation 1

where v is the number of events observed (e.g., the number of reaction vessels) and μ is the expected average number of events per trial (e.g., the average number of analyte molecules per reaction vessel.

If the concentrations used are much less than approximately 4×10⁻¹¹ M, the expected average number of analyte molecules per well becomes exceptionally low, the distribution is narrowed, and the probability of observing anything other than zero or one analyte molecules per well is improbable in all experimental cases. At these low concentrations, the relationship between the percentage of active reaction vessels and the bulk analyte molecule concentration is approximately linear. Thus, based on this knowledge, the array of the present invention can be used to determine the concentration of analyte molecules by a simple digital readout system (e.g., “counting” of active wells) as described herein in combination with a suitable calibration.

According to one embodiment, the quantification method of the present invention can be performed as follows. The method employs a digital readout system (also referred to as a “binary readout system”) that involves first detecting the analyte molecules in the plurality of reaction vessels by any detection method as described herein. The number of reaction vessels which comprise an analyte molecule is then counted and a percentage of the total number of reaction vessels which comprise an analyte molecule is calculated. That is, utilization of a yes or no response, in conjunction with the high-density array of reaction vessels, permits the digital readout of bulk concentrations of analyte molecules. In some embodiments, this readout is accomplished by counting the number of reaction vessels containing at least one labeling agent molecule, with the resulting number of reaction vessels comprising a labeling agent molecule corresponding to the number of reaction vessels comprising an analyte molecule. Given the large number of reaction vessels simultaneously interrogated in the array of the present invention, the ratio of analyte molecules to reaction vessels may be at least about 1:100, at least about 1:1000, at least about 1:10,000, as the large number of reaction vessels provides a statistically significant signal even at this low ratio.

In some embodiments, without being limited by theory, it is believed that the quantification method of the present invention may only be limited by the number of individual reaction vessels that can be fabricated and interrogated. Thus, expanding the number of reaction vessels may increase both the dynamic range and the sensitivity of the assay. For example, increasing the number of reaction vessels by a factor of ten may decrease the ratio of analyte molecules to reaction vessels by a factor of ten, thereby increasing the dynamic range and/or sensitivity of the assay. As mentioned above, in some embodiments, an array will comprise between about 1,000 and about 50,000, between about 1,000 and about 1,000,000, between about 1,000 and about 10,000, between about 10,000 and about 100,000, between about 100,000 and about 1,000,000, between about 1,000 and about 100,000, between about 50,000 and about 100,000, between about 20,000 and about 80,000, between about 30,000 and about 70,000, between about 40,000 and about 60,000, or about 50,000 reaction vessels.

In some embodiments, accuracy of this technique may be compromised above and below the thresholds of the dynamic range. For example, as the concentration of the analyte molecules goes below the lower limit of the dynamic range, the number of analyte molecules may be too low to observe a sufficient number of occupied wells. In such a situation, the number of reaction vessels could be decreased in order to make sure that a statistically significant number of them are occupied by an analyte molecule, the volume of the reaction vessels could be increased, and/or the sample tested could be concentrated. Results for extremely dilute concentrations may have large relative errors associated with them, due to the very small number of reaction vessels that are expected to show activity. In other cases, the ultimate upper limit to this technique may occur when 100% of the reaction vessels contain at least one analyte molecule. At this limit, discrimination between two solutions of high analyte molecule concentrations may not be feasible. In such a situation, to provide a more accurate test, a greater number of reaction vessels could be used, and/or the volume of each reaction vessel could be reduced, and/or the concentration of the sample could be reduced, e.g., through dilution.

In the range where the fraction of reaction vessels containing at least one analyte molecule is less than about 20%, the probability that any well contains two or more analyte molecules is very small and the number of analyte molecules closely matches the number of occupied reaction vessels. Between 20% occupied and 100% occupied, an increasing number of wells may contain more than one analyte molecule, however Gaussian statistics can still be used to correlate occupancy fraction with concentration with reasonable accuracy until the occupancy fraction approaches 100%.

As alluded to above, the practical dynamic range of the method may be increased in several ways. In one approach, the sample and/or solution carrying the analyte molecules may be diluted, e.g. by a factor of 10 or more. Both the solution comprising the analyte molecules and the diluted solution comprising the analyte molecules may be assayed concurrently using the method of this invention. The dynamic ranges of the two assays may overlap, but be offset by the dilution factor, hence extending the dynamic range.

In some embodiments, multiple arrays of reaction vessels can be used, each array having reaction vessels with differing volumes, differing binding surface areas, or differing density and/or type of capture components on the binding surface. These configurations can be constructed as either distinct arrays or as one large array with distinct sub-arrays with varying characteristics. Since the probability of an analyte molecule being detected in a given reaction vessel can be related to volume, binding surface area, and capture component density, the sub-arrays may be designed to provide different sensitivity ranges. Thus, with such configurations the effective range of the combined array may be extended.

In certain embodiments, after partitioning of the solution containing analyte molecules across an array of reaction vessels, less than about 20% of the total number of the plurality of reaction vessels will contain at least one analyte molecule (i.e., at least 80% of reaction vessels will be free of analyte molecules). Under such circumstances, the number of reaction vessels containing at least one analyte molecule will typically fall within the linear range of a Poisson distribution. In another embodiment, more than about 20% but less than about 60% of the total number of reaction vessels contain at least one analyte molecule. Under such circumstances, the number of reaction vessels containing at least one analyte molecule will typically fall within the non-linear range of a Poisson distribution. In another embodiment, more than about 60% but less than about 95% of the total number of reaction vessels contains at least one analyte molecule. Under such circumstances, the number of reaction vessels containing at least one analyte molecule will typically fall within the highly non-linear range of a Poisson distribution. In embodiments where greater than about 60% of the total number of reaction vessel contains at least one analyte molecule, it may be desirable to decrease the percentage of reaction vessels which comprise at least one analyte molecule (e.g., to less than about 20%). This may be accomplished using any suitable technique discussed herein, for example, diluting the fluid comprising the analyte molecules and/or increasing the number of reaction vessels. In some cases, less than about 1%, less than about 5%, less than about 10%, less than about 20%, less than about 40%, less than about 60%, less than about 80%, less than about 90%, less than about 95%, or less than about 99% of the total number of the plurality of reaction vessels will contain at least one analyte molecule. In certain embodiments, more than about 1%, more than about 5%, more than about 10%, more than about 20%, more than about 40%, more than about 60%, more than about 80%, more than about 90%, more than about 95%, or more than about 99% of the total number of the plurality of reaction vessels will contain no analyte molecules. In some cases, at least about 95%, at least about 90%, at least about 80%, at least about 40%, at least about 5% of the reaction vessels contain no analyte molecule.

In some embodiments, the invention provides a method of determining the concentration of the analyte molecules in a fluid, the method comprising dividing the fluid containing the analyte molecules into a plurality of second, smaller fluid samples of essentially equal volume so that a statistically significant fraction of the second, smaller fluid samples contain either no analyte molecules or a single analyte molecule; determining the presence or absence of an analyte molecule in each of the second, smaller fluid samples so as to identify the number of second, smaller fluid samples that contain an analyte molecule; and determining the concentration of analyte molecules in the fluid sample to be tested from the number of second, smaller samples that contain the analyte molecules.

In certain embodiments, the present invention provides a method for determining the concentration of analyte molecules in a fluid, the method comprising the partitioning at least a portion of the analyte molecules in the fluid across a plurality of reaction vessels so that at least some of the reaction vessels contain an analyte molecule and at least some of the reaction vessels contain no analyte molecules; determining the presence or absence of an analyte molecule in each reaction vessel to identify the number of reaction vessels that contain an analyte molecule and/or to identify the number of reaction vessels that contain no analyte molecules; and determining the concentration of analyte molecules in the fluid at least in part from the number of reaction vessels that do or do not contain an analyte molecule. In some embodiments, at least about 99%, at least about 95%, at least about 90%, at least about 80%, at least about 40%, at least about 20%, at least about 10% at least about 5%, at least about 1%, and the like of the reaction vessels do not contain an analyte molecule. In some embodiments, the concentration of analyte molecules in the fluid sample is determined at least in part using a calibration curve, a Poisson distribution analysis and/or a Gaussian distribution of the number of reaction vessels that contain at least one or one analyte molecule. In other embodiments, the concentration of analyte molecules in the fluid sample is determined at least in part by a Gaussian distribution analysis of the number of reaction vessels that contain an analyte molecule.

In certain embodiments, the present invention provides a method of determining the concentration of analyte molecules in a fluid, the method comprising exposing the fluid to a plurality of reaction vessels under conditions so that at least one analyte molecule is captured in at least some of the reaction vessels, wherein each reaction vessel comprises a microwell and an optional sealing component and each reaction vessel defines a binding surface that has a capture component immobilized thereon; determining the presence or absence of an analyte molecule in each reaction vessel so as to identify the number of reaction vessels that contain an analyte molecule and/or the number of reaction vessels that do not contain an analyte molecule; and determining the concentration of analyte molecules in the fluid sample to be tested from the number of reaction vessels that contain and/or do not contain an analyte molecule. In some embodiments, at least about 99%, at least about 95%, at least about 90%, at least about 80%, at least about 50%, at least about 20%, at least about 10% at least about 5%, at least about 1%, and the like of the reaction vessels contain either zero or one analyte molecule. In some embodiments, the concentration of analyte molecules in the fluid sample is determined at least in part using a calibration curve, a Poisson distribution analysis and/or a Gaussian distribution analysis of the number of reaction vessels that contain at least one or one analyte molecule.

In certain embodiments, the present invention provides a method of determining the concentration of analyte molecules in a fluid, the method comprising exposing the fluid to a plurality of reaction vessels under conditions so that at least one analyte molecule is captured in at least some of the reaction vessels, wherein each reaction vessel comprises a microwell and an optional sealing component and each reaction vessel defines a binding surface that has a capture component immobilized thereon; determining the presence or absence of an analyte molecule in each reaction vessel so as to identify the number of reaction vessels that contain an analyte molecule and/or the number of reaction vessels that do not contain an analyte molecule; and determining the concentration of analyte molecules in the fluid sample to be tested from the number of reaction vessels that contain and/or do not contain an analyte molecule. In some embodiments, at least about 99%, at least about 95%, at least about 90%, at least about 80%, at least about 50%, at least about 20%, at least about 10% at least about 5%, at least about 1%, and the like of the reaction vessels contain either zero or one analyte molecule. In some embodiments, the concentration of analyte molecules in the fluid sample is determined at least in part using a calibration curve, a Poisson distribution analysis and/or a Gaussian distribution analysis of the number of reaction vessels that contain at least one or one analyte molecule.

In certain embodiments, the present invention provides a method of determining the concentration of analyte molecules in a fluid sample to be tested, the method comprising partitioning at least a portion of the analyte molecules in the fluid into a plurality of reaction vessels, so that, for substantially all of the reaction vessels, each reaction vessel contains either no analyte molecules or a single analyte molecule; determining the presence or absence of an analyte molecule in a plurality of reaction vessels to provide a fraction of the interrogated reaction vessels that contain an analyte molecule; and determining the concentration of analyte molecules in the fluid from the fraction of interrogated reaction vessels that contain an analyte molecule.

In certain embodiments, the present invention provides a method of determining the concentration of analyte molecules in a fluid, the method comprising partitioning the fluid into a plurality of second, smaller fluid samples of equal volume so that at least some of the second, smaller fluid samples contain either a single analyte molecule or no analyte molecules, (b) determining the presence or absence of an analyte molecule in at least a subset of the second samples so as to identify the fraction of second samples in the subset that contain an analyte molecule; and determining the concentration of analyte molecules in the sample to be tested from the fraction of second samples of the subset that contain the analyte molecules.

In some embodiments, a method of the present invention may be used for the detection of analyte molecules in a fluid. For example, a method of detecting analyte molecules in a fluid may comprise providing a fluid containing the analyte molecules and an array, the array comprising a plurality of reaction vessels; contacting the array with the fluid such that the ratio of the number of analyte molecules in the fluid contacted with the array to the number of reaction vessels in the array is less than 1:1; and determining the number of reaction vessels which contain an analyte molecule. In some cases, the ratio of the number of analyte molecules in the fluid contacted with the array to the number of reaction vessels in the array is less than about 1:5, less than about 1:10, less than about 1:100, or less than about 1:500.

In certain embodiments, a method of detecting analyte molecules in a fluid according to the invention comprises providing a fluid and an array, the fluid comprising at least one analyte molecule at a first concentration, the array comprising a plurality of reaction vessels; diluting the fluid to create a diluted fluid, wherein the diluted fluid comprises the analyte molecules at a second concentration; contacting the array with the diluted fluid such that the ratio of analyte molecules to the total number of reaction vessels in the array is between 1:1 and 1:500; and determining the number of vessels of said array which contain an analyte molecule. In some cases, the ratio is less than about 1:1, less than about 1:5, less than about 1:10, less than about 1:100, or less than about 1:500.

### Multiplexing and Reuse of an Array

In accordance with one detection embodiment, sensor redundancy is used. In this embodiment, a plurality of reaction vessels comprising identical capture components referred to as “subpopulations” are used. That is, each subpopulation comprises a plurality of identical capture components present in reaction vessels of an array. Further, according to one embodiment, each subpopulation comprises a plurality of reaction vessels comprising identical capture components. By using a number of identical capture components for a given array, the optical signal from each microwell can be combined for the subpopulation and any number of statistical analyses run, as outlined below. This can be done for a variety of reasons. For example, in time varying measurements, redundancy can significantly reduce the noise in the system. For non-time based measurements, redundancy can significantly increase the confidence of the data.

The number of subpopulations, according to one embodiment, can range from 2 to any number of subpopulations possible given the limitations of the overall size of the array(s) and the number of different capture components. Alternatively, the number can range from about 2 to about 10. In a further alternative, the number can range from about 2 to about 5.

In one embodiment, a plurality of identical capture components is used. As will be appreciated by those in the art, the number of identical capture components in a subpopulation will vary with the application and use of the sensor array (e.g., the number of capture component per well may vary). In general, anywhere from 2 to thousands, from about 2 to 100, from about 2 to about 50, or from about 5 to about 20 of identical capture components may be used in a given subpopulation. In one case, about 10 identical capture components may be used.

A reaction vessel array according to one embodiment, utilizes a plurality of capture components that are directed to a single target analyte but are not identical. In other words, the capture components bind to different binding sites on an analyte molecule. This embodiment thus provides for more than one different capture component on each binding surface or different capture components on different binding surfaces. In one example, a single analyte is interrogated by a first and a second capture component, each of which is capable of binding to a different site on the analyte molecule. This adds a level of confidence to the assay as non-specific binding interactions can be statistically reduced. In this embodiment, when proteinaceous analytes are evaluated, the assay can utilize capture components that bind to different parts of the target. For example, two or more antibodies (or antibody fragments) to different portions of the same analyte protein may be used as capture components, (e.g., antibodies directed towards different epitopes′). Similarly, when nucleic acid analyte molecules are to be evaluated, redundant nucleic acid probes may be used as capture components that are overlapping, adjacent, or spatially separated in the gene. In most cases, the two such capture components would not compete for a single binding site, and adjacent or separated probes are used.

In certain such embodiments, a plurality of different capture components may be used. For example, about 2 to about 20, about 2 to about 10, from about 2 to about 5. In other cases, about 2, about 3, about 4, or about 5 different capture components may be used. However, as above, more may also be used, depending on the application.

In certain embodiments, the plurality of reaction vessels of certain embodiments of the present invention use a plurality of different capture components that are directed to a plurality of target analyte molecules, which can be the same or different. Such embodiments can include more than one different capture components on each binding surface or different capture components on different binding surfaces. In one example, a plurality of a first analyte molecule and a plurality of a second analyte molecule may be provided to which a plurality of a first capture component and a plurality of a second capture component on the same binding surfaces or on different binding surfaces are capable of binding.

In such embodiments, more than one type of analyte molecule may be identified. For example, a first analyte molecule and a second analyte molecule may be identified so long as, in the case of direct assays, each different analyte molecule interacts differently with one or more first binding ligand types. In one embodiment, the analyte molecules may be identified using one or more first binding ligands having specificity to particular analyte molecules or particles wherein each first binding ligand converts precursor labeling agents into a uniquely identifiable labeling agent. Thus, each specific analyte molecule can be distinguished based upon the detectable signal produced by reaction of the first binding ligand with the precursor labeling agent.

In one particular approach, referred to as a sequential approach, the analyte molecules are identified using the same or different binding ligands. In this approach, the one or more analyte molecules of interest are captured on one or more binding surfaces. A first type of first binding ligand associates with the first analyte molecules. The presence of the first type of first binding ligand can be determined. Thereafter, the first type of first binding ligand is removed, for example, by washing. Then a second, different type of first binding ligand associates with a second, different type of analyte molecule. The presence of the second type of first binding ligand may be determined. Thereafter, the second type of first binding ligand may be removed by washing and the process repeated as desired to detect additional types of analyte molecules. It is understood that, in this approach, the same or different precursor labeling agent molecule type may be converted by the first and the second types of first binding ligand. It is understood that essentially any precursor labeling agent described herein can potentially be used in this approach. It is understood that the sequential reactions can be performed using labeling agent molecules (or labeling agent reactants), each of which produce the same or different colors.

In certain embodiments, a plurality of different capture component types can be used, for example, from about 2 to about 100, from about 2 to about 20, from about 2 to about 10, or about 2, 3, 4 or 5, 6, 7, 8, 9. However, as above, more may also be used, depending on the application.

In another approach, referred to as a spatial approach, it is possible to use either (i) two different capture component types disposed within separate regions of a binding surface, (ii) two different first binding ligand types that are applied to an separate regions of a binding surface, or (iii) a combination or (i) and (ii).

In the first example of the spatial approach, different capture component types having different specificity are applied to different regions of the binding surface. For example, this can be achieved by placing microdroplets on different regions of a fiber microwell array if it is used as a binding surface or to a sealing component if it is used as the binding surface. Each micro-droplet would contain a different type of capture component that would functionalize the surface it contacts with different analyte capture specificity In this way, depending on the size of the droplets, it is possible to make an array of different capture component types on the binding surface that are spatially discrete. The number of multiplexed analyte molecules that could be detected in this manner would depend on the size of the different capture component regions and the size of the array of reaction vessels.

In the second example of the spatial approach, it is understood that the analyte molecules of interest can be captured uniformly across a binding surface or within discrete regions of the binding surface. In this approach, however a first type of first binding ligand is applied to a first region of the binding surface and the presence of a first type of analyte molecule is detected. Simultaneously or sequentially, a second type of first binding ligand is applied to a second region of the binding surface and the presence of a second type of analyte molecule is detected.

It is understood that that each of the different assay configurations above, including the use of different types of capture components directed to different types of analyte molecules and the plurality of capture components directed to the same analyte molecule, can also be utilized for quantification as described herein.

In addition, under certain circumstances it is understood that the array of reaction vessels may be reused during a subsequent assay. In this approach, a log of the wells that contained analyte in a first assay is recorded and then in a subsequent assay the wells that previously contained analyte molecules are mathematically subtracted from the array of reaction vessels interrogated in a subsequent assay.

### Systems and Kits

In some cases, the present invention provides systems and/or kits for detecting analyte molecules in a fluid sample. In some cases, the systems comprise an array comprising a plurality of reaction vessels, at least one binding ligand type, and at least one precursor labeling agent type.

In some embodiments, the system and/or kit may provide an array comprising a plurality of reaction vessels, each reaction vessel having a volume not exceeding about 10 attoliters, about 100 attoliters, about 1 femtoliter, about 50 femtoliters, about 100 femtoliters, about 1 picoliter, about 50 picoliters, and the like. Additionally, each reaction vessel may contain at least one capture component immobilized within each reaction vessel having binding specificity for an analyte molecule. In some cases, the capture component may not have binding specificity for an analyte molecule, but rather for a molecule or other entity included that has binding specificity for an analyte molecule. In some instances, the binding constant of the analyte molecule or particle to the capture component is at least about 10⁴ M⁻¹, about 10⁵ M⁻¹, about 10⁶ M⁻¹, about 10⁷ M⁻¹, about 10⁸ M⁻¹, about 10⁹ M⁻¹ or greater.

In some cases, the system and/or kit provides at least one binding ligand type having binding specificity for the analyte molecules or particles. Examples of binding ligands are described in more detail herein. In some instances, the binding constant of the analyte molecule or particle to a binding ligand is at least about 10⁴ M⁻¹, at least about 10⁵ M⁻¹, at least about 10⁶ M⁻¹, at least about 10⁷ M⁻¹, at least about 10⁸ M⁻¹, at least about 10⁹ M⁻¹ or more.

In some embodiments, the system and/or kit also provides at least one type of precursor labeling agent. The labeling agent molecules may be solubilized or suspended in a liquid. As discusses herein, the precursor labeling agent molecules are converted upon exposure to the first binding ligand to labeling agent molecules that are insoluble and/or that become immobilized within a reaction vessel.

The system and/or kit may also comprise other components, all of which have been discussed herein. For example, the kit may further comprise a second binding ligand type (and third binding ligand type, etc). The kit may also comprise a sealing component. In some cases, the kit may also comprise at least one labeling agent reactant, wherein the at least one labeling agent reactant is able to convert, upon exposure to labeling agent molecules, into a detectable product.

The following examples are included to demonstrate various embodiments of the invention. Those of ordinary skill in the art should, in light of the present disclosure, appreciate that many changes can be made in the specific embodiments which are disclosed and still obtain a like or similar result without departing from the spirit and scope of the invention. Accordingly, the following examples are intended to illustrate certain embodiments of the present invention, but do not exemplify the full scope of the invention.

### EXAMPLE 1

This example outlines the materials used in the following examples. Optical fiber bundles were purchased from Schott North America, Inc (Southbridge, Mass.). In some cases, the core glass of the optical fiber bundles comprised barium, lanthanum, boron, silica, and aluminum. The refractive index of the core glass was 1.694, and the density was 4.23 g/cc. The cladding glass comprised silica, lead, potassium, sodium, and aluminum. The refractive index of the clad glass was 1.559, and the density was 3.04 g/cc. The fiber array was a bundle of 50,000 individual fibers, each with a core diameter of 4.5 μm and the center-to-center spacing of the cores was 8 μm.

Non-reinforced gloss silicone sheets were obtained from Specialty Manufacturing Inc. (Saginaw, Mich.). Hydrochloric acid, 4-(dimethylamino) pyridine, 3-aminopropyl trimethoxysilane, triethylamine, N,N-Disuccinimidyl carbonate, anhydrous ethanol, and N,N-Dimethyl formamide were all from Sigma-Aldrich (Saint Louis, Mo.). Monoclonal anti-human TNF-α antibody, biotinylated polyclonal anti-human TNF-α antibody, and recombinant human TNF-α were purchased from R&D systems, Inc (Minneapolis, Minn.). Tyramide signal amplification kit was from Invitrogen (Carlsbad, Calif.). Phosphate buffered saline, Blocker BSA (10%), and 10% TWEEN 20 were obtained from Pierce (Rockford, Ill.). Fiber polisher was from Allied High Tech Products, Inc. (Rancho Dominguez, Calif.).

### EXAMPLE 2

Optical fibers were interrogated using the following experimental set-up. An upright epifluorescence microscope was custom built containing a mercury light source, excitation and emission filter wheels, objectives, and a CCD camera for acquiring fluorescence images. A mechanical platform that housed the silicone sheet was built underneath the microscope stage. The stage may be raised up to bring the silicone sheet into contact with the end of the optical fiber array that was mounted onto the microscope stage. This mechanism allows for individual reaction vessels to be sealed during the signal development for immunoassays.

The set-up is similar to that as described above in FIG. 18A and is also pictured in FIG. 18B. The imaging system used for collecting the data integrated an Olympus BX-61 microscope system with a Cooke Corporation Sensicam QE CCD camera, 474. The BX-61 microscope is an upright microscope specifically designed for fluorescence detection. The scope can house UIS2 optics, which, in comparison to standard optics, offers increased signal-to-noise ratio, high light transmission, and diverse illumination capabilities. 10× and 20× UMPlanFl objectives (e.g., 470), which have a NA of 0.3 and 0.5, respectively, were installed on the BX-61 microscope. Wavelength specific filter sets are held in a cube, which is stored in a rotating wheel within the microscope. The BX-61 can hold 6 cubes for easy access to wavelengths specific for a number of fluorophores. Filter sets are typically purchased from Chroma Technology Corporation and are compatible with the cubes on the BX-61. The resorufin filter cube (Chroma Technology filter set #41010) was used for all of the enzyme amplification experiments described here. This filter set uses a HQ577/10x excition filter, a 585 long-pass dichroic mirror, and a HQ620/60m emission filter.

A 6-axis mechanical platform was constructed beneath the microscope stage, which was used to house a non-reinforced silicone gasket material (sealing component) to be applied to the fiber optic array. Arrays were mounted on the microscope stage using a fiber array holder fabricated to secure and position the fiber array on the stage. A droplet of beta-galactosidase substrate (RDG) (precursor labeling agent molecule) was placed on the silicone gasket material, and put into contact with one end of the fiber array. The mechanical platform was used to move the silicone sheet into contact with the distal end of the etched optical fiber array, creating an array of isolated femtoliter reaction vessels.

### EXAMPLE 3

Optical fiber bundles arrays were prepared using the following techniques. Optical fiber bundles approximately 5 cm long were first polished on the polishing machine using 30, 9, and 1 micron-sized diamond lapping films. The polished fiber bundles were chemically etched in a 0.025 M HCl solution for approximately 115 seconds to generate high-density (50,000) microwell arrays and then immediately submerged into water to quench the reaction. To remove impurities from etching, the etched fibers were sonicated for 5 seconds and washed in water for 5 min. The fibers were then dried under argon and silanized in a 2% silanization solution that was prepared by mixing 950 ul of anhydrous ethanol, 50 ul of water, and 20 ul of 3-aminopropyl trimethoxysilane for 30 min, and then washed with anhydrous ethanol for 10 min and dried under nitrogen. The silanized fibers were cured at 80° C. for 30 min and cooled to room temperature. The optical fiber arrays were then further activated with N,N-Disuccinimidyl carbonate, a homo-bifunctional cross-linker, to introduce NHS ester groups on the arrays for the next immobilization of capture antibodies. The reaction was completed in a mixture with 80 mg N,N-Disuccinimidyl carbonate, 4 mg 4-(dimethylamino)pyridine, and 125 ul of triethylamine in 1.6 ml of DMF after 4 hrs incubation and followed by a thorough washing of fibers using anhydrous ethanol for 10 min. Finally, the fiber arrays were incubated with capture antibodies (monoclonal anti-human TNF-α antibody, 250 ug/ml in PBS) overnight at room temperature, and washed with PBS.

### EXAMPLE 4

The following is an example a non-limiting example of one assay of the present invention. A fiber optic array was prepared in a similar manner according to Example 3. A stock solution of recombinant human TNF-α protein (571 nM) was made by reconstituting 50 μg of the protein with 1 ml of PBS. Different concentrations of the TNF-α targets (1 pM, 500 fM, 200 fM, 80 fM, and 32 fM) were prepared by diluting the stock solution with PBS+1% BSA. The functionalized fiber-optic single molecule arrays were blocked with PBS+1% BSA for 8 hrs at 4° C. Three blocked single molecule arrays were incubated with each different concentration of TNF-α targets target analyte molecules) as well as the negative control overnight at room temperature, followed by washing with PBS+1% BSA+0.1% Tween 20 for 20 min at room temperature. The target-bound single molecule arrays were then incubated with 500 pM of biotinylated anti-human TNF-α antibody (first binding ligand) diluted from the stock (˜333 nM) with PBS+1% BSA for 1 hr at room temperature. The arrays were washed with PBS+1% BSA+0.1% Tween 20 for 20 min. Streptavidin-HRP conjugate (100 μg) was reconstituted in 200 ul of PBS to make a stock solution of 500 μg/ml. The arrays were then reacted with the diluted streptavidin-HRP conjugate solution (second binding ligand) at 5 μg/ml for 1 hr, and washed again with PBS+1% BSA+0.1% Tween 20 for 20 min.

### EXAMPLE 5

The following is an example of signal development using catalyzed reporter deposition. A tyramide-Alexa 488 stock solution was prepared by dissolving the solid material provided with a tyramide signal amplification kit (e.g., from Molecular Probes, Oregon) in 150 ul of DMSO. A working solution containing 0.015% H₂O₂ was made by adding 1 μl of 30% H₂O₂ to 200 μl of amplification buffer provided with the kit and then addition of 10 μl of this intermediate dilution (0.15%) to 100 μl of amplification buffer. This working solution was then used to make 10- or 100-fold dilution of the tyramide-Alexa 488 stock for the signal development for ELISAs on the fiber-optic single molecule array.

The catalyzed reporter deposition on the single molecule array using the HRP system was performed in two different ways. In one instance, the single molecule arrays prepared as described in Example 4 were incubated with the above working solution containing tyramide-Alexa 488 (precursor labeling agent) in an open vial for 15 min. In the other instance, the tyramide working solution was sealed into individual reaction vessels on the single molecule array on the microscope for 30 min. After the signal development, the arrays were thoroughly washed with PBS for 20 min and imaged on the microscope (excitation: 496 nm/emmission: 520 nm).

### EXAMPLE 6

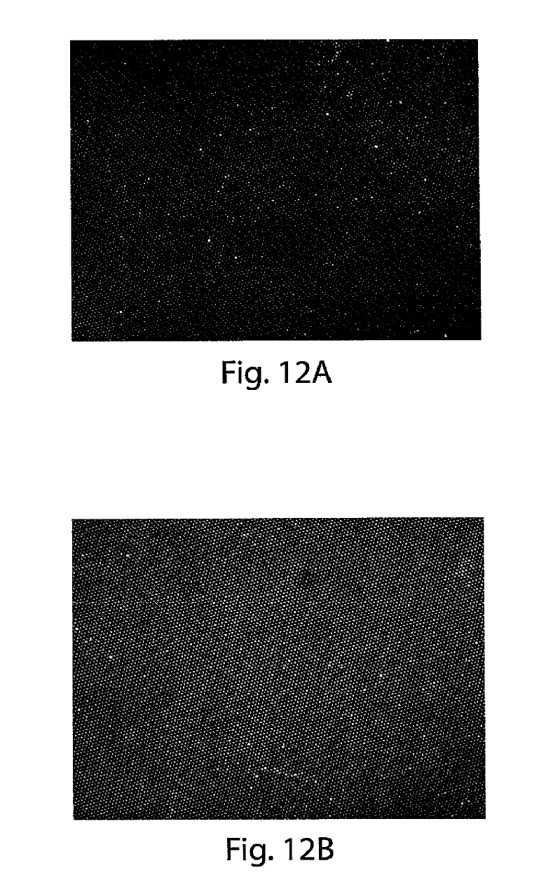

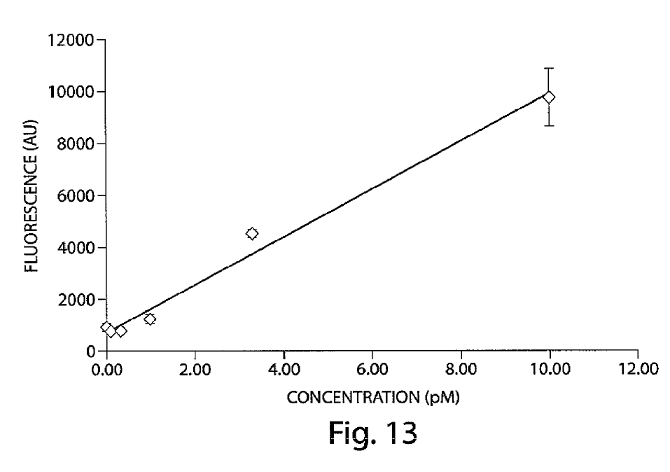

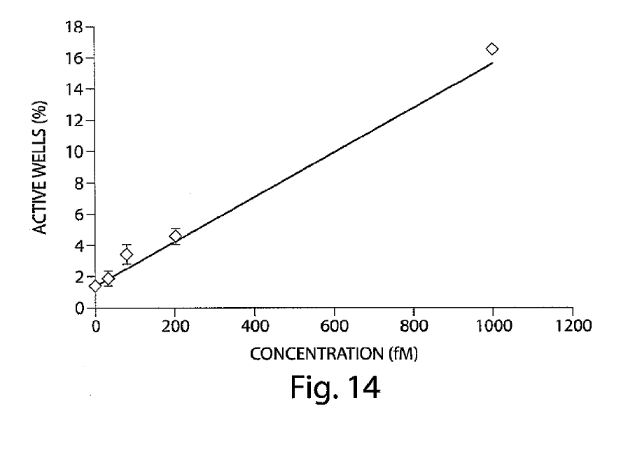

The arrays of the present invention may or may not be sealed when using the catalyzed reporter deposition method. The signal development for single molecule detection using the catalyzed HRP reporter system described in Example 5 was compared between sealing an array and without sealing an array for tyramide-Alexa 488 deposition. To seal the array, each fiber bundle was mounted on the scope individually and the tyramide working solution (1:10 dilution from the stock) was sealed with the silicone sheet and isolated into individual reaction vessels with an incubation time of 30 min for tyramide deposition. Without sealing the single molecule array on the microscope, signal development were performed with multiple arrays in a open vial with a more diluted tyramide working solution (1:100 dilution) and a shorter reaction time (15 min). In this example, a relatively high background signal was recorded from the image without sealing as compare to the array that was sealed. In addition, a greater viability in number of positive wells caused higher detection limits. Without being bound by theory, both of the above observations may be due to the diffusion and deposition of tyramide molecules in the bulk solution into neighboring wells even with the absence of HRP, resulting in high backgrounds and false positive signals. It should be noted, that in some instance, improved results may be observed when not sealing the array, as opposed to sealing the array. Well-sealed arrays ensure the deposition of reporter molecules only within the reaction vessels with the presence of the bound targets and HRP. FIGS. 12A and 12B show images of the fiber optic array analyzed in this example, with and without sealing of the array, respectively. FIG. 10 shows a calibration curve determined using arrays that were not sealed while FIG. 11 shows calibration curve determined using arrays that were sealed. In this embodiment, a greater variability in the number of wells detected was observed when the array was not sealed, which results in a higher limit of detection. In some instances, however, the results may be reversed and not sealing the array may result in a higher limit of detection.

### EXAMPLE 7

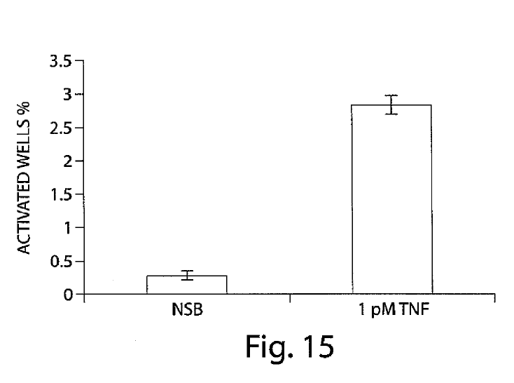

The following is an example of the variation in the limit of detection observed for fiber optic array using a sealed array. The detection limit of TNF-α was determined on the fiber-optic single molecule arrays using catalyzed reporter deposition based on the HRP (binding ligand) and tyramide precursor labeling agent) Alexa 488 system with sealing. Five different concentrations of TNF-α (target analyte molecule) were included to generate the calibration curve as well as the negative control with the absence of TNF-α target. The percentage of detectable wells was obtained for each array. For each concentration level, three fiber arrays were used, and the averaged data from the three replicates was used to plot the calibration curve. Overnight target incubation was performed for all target concentrations to obtain a lower detection limit. Buffers with high stringency were used for washing between incubation steps to reduce any nonspecific interactions. As shown in FIG. 15, a relatively low NSB (1.43+/−0.056%) was obtained from the negative control. A detection limit of approximately 32 fM was achieved for TNF-α with the detectable wells (1.93+/−0.47%) greater than the signal from NSB plus three times the standard deviations of NSB (1.59%).

Fluorescent images of the fiber optic arrays were analyzed using IPlab software (Scanalytics, Fairfax, Va.). The number of microwells in the fiber-optic single molecule array with fluorescence intensity above a background threshold (e.g, background signal as determined by completing the assay with a sample that does not comprise analyte molecules or particles) was counted for each image. The percentage of these positive wells was used to quantify the concentration of targets using Poisson statistics, as discussed herein.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

What is claimed:

1. A method of detecting analyte molecules or particles in a fluid sample containing or suspected of containing analyte molecules or particles, comprising:
partitioning the fluid sample across an array comprising a plurality of reaction vessels, so that at least some of the reaction vessels contain no analyte molecules or particles and at least some of the reaction vessels contain at least one analyte molecule or particle;
immobilizing at least one binding ligand with respect to an analyte molecule or particle within each reaction vessel containing at least one analyte molecule or particle;
exposing the at least one binding ligand to a liquid in which is solubilized or suspended precursor labeling agent molecules, wherein exposure of the precursor labeling agent molecules to the at least one binding ligand converts at least some of the precursor labeling agent molecules into a labeling agent molecules which are insoluble in the liquid and/or which become immobilized within the reaction vessel; and
determining from detecting the presence of the labeling agent molecules the number of reaction vessels which contain an analyte molecule or particle.

2. The method of claim 1, wherein the percentage of reaction vessels which comprise at least one analyte molecule or particle is less than about 10% of the total number of reaction vessels.

3. The method of claim 1, wherein the percentage of reaction vessels which comprise at least one analyte molecule or particle is less than about 5% of the total number of reaction vessels.

4. The method of claim 1, wherein the percentage of reaction vessels which comprise at least one analyte molecule or particle is less than about 1% of the total number of reaction vessels.

5. The method of claim 1, wherein the percentage of reaction vessels which comprise at least one analyte molecule or particle is less than about 0.1% of the total number of reaction vessels.

6. The method of claim 1, wherein a first and a second binding ligand is provided.

7. The method of claim 6, wherein the first binding ligand is associated with an analyte molecule or particle and the second binding ligand is associated with the first binding ligand.

8. The method of claim 1, wherein the array of reactions vessels comprises a plurality of fiber optic microwells.

9. The method of claim 1, wherein the volume of a reaction vessel is between about 10 attoliters and about 50 picoliters.

10. The method of claim 1, wherein each reaction vessel comprises at least one analyte capture component.

11. The method of claim 10, where the analyte molecules or particles are immobilized in the reaction vessel by associated with at least one analyte capture component.

12. The method of claim 1, wherein each reaction vessel comprises at least one labeling agent capture component.

13. The method of claim 12, wherein the labeling agent molecules are immobilized in the reaction vessel by associating with the at least one labeling agent capture component.

14. The method of claim 1, wherein the at least one binding ligand comprises an enzymatic component.

15. The method of claim 14, wherein the enzymatic component is horseradish peroxidase.

16. The method of claim 1, wherein the at least one binding ligand comprises a nanoparticle.

17-41. (canceled)

42. A system for detecting analyte molecules or particles, comprising;
an array comprising a plurality of reaction vessels, wherein at least some of the reaction vessels contain no analyte molecules or particles and at least some of the reaction vessels contain at least one analyte molecule or particle;
at least one binding ligand immobilized with respect an analyte molecule or particle within each reaction vessel containing an analyte molecule or particle; and
precursor labeling agent molecules solubilized or suspended in a liquid contained within the reaction vessels, wherein the precursor labeling agent molecules are able to convert upon exposure to a binding ligand to labeling agent molecules that are insoluble within the liquid and/or that become immobilized within reaction vessels containing a binding ligand.

43-75. (canceled)

76. A method of detecting analyte molecules or particles in a fluid sample containing or suspected of containing analyte molecules or particles, comprising:
providing a fluid sample containing or suspected of containing analyte molecules or particles;
immobilizing at least one binding ligand with respect to at least some of the analyte molecules or particles;
exposing the at least one binding ligand to a liquid in which is solubilized or suspended precursor labeling agent molecules, wherein exposing the precursor labeling agent molecules to the at least one binding ligand converts at least some of the precursor labeling agent molecules into labeling agent molecules which are insoluble in the liquid and/or which become immobilized within the reaction vessel; and
determining a measure of the concentration of the analyte molecules or particles in the fluid sample based on the detection of labeling agent molecules wherein the true concentration of the analyte molecules or particles in the fluid sample is less than about 100×10⁻¹⁵ molar, and wherein the measure of the concentration determined in the determining act differs from the true concentration by no greater than 10%.

77-80. (canceled)

81. A kit for detecting analyte molecules or particles comprising:
an array comprising a plurality of reaction vessels, each reaction vessel having a volume not exceeding about 100 femtoliters and each reaction vessel containing at least one analyte capture component immobilized or able to become immobilized within the reaction vessels having binding specificity for the analyte molecules or particles;
at least one binding ligand having binding specificity for the analyte molecules or particles; and
precursor labeling agent molecules able to be solubilized or suspended in a liquid, wherein the precursor labeling agent molecules are able to convert upon exposure to the at least one binding ligand to labeling agent molecules that are insoluble within the liquid and/or that become immobilized within the reaction vessels.

82-112. (canceled)

113. A method of detecting analyte molecules or particles in a fluid sample containing or suspected of containing analyte molecules or particles, comprising:
partitioning the fluid sample across an array comprising a plurality of reaction vessels, so that at least some of the reaction vessels contain no analyte molecules or particles and at least some of the reaction vessels contain at least one analyte molecule or particle;
immobilizing at least one binding ligand comprising a binding site with respect to an analyte molecule or particle within each reaction vessel containing at least one analyte molecule or particle;
applying an enzymatic component to the array and capturing the enzymatic component with the binding site;
contacting the enzymatic component with precursor labeling agent molecules, wherein the precursor labeling agent molecules are converted to labeling agent molecules upon contact with enzymatic components;
detecting the labeling agent molecules; and
determining from the detection of the labeling agent molecules the number of reaction vessels which contain an analyte molecule or particle.

114-146. (canceled)
